(19) United States
(12) Patent Application Publication
(10) Pub. No.: US 2024/0275546 A1
(43) Pub. Date: Aug. 15, 2024

(54) CHANNEL STATE INFORMATION ENHANCEMENT FOR TRANSMISSION CONFIGURATION PARAMETER SELECTION

(71) Applicant: QUALCOMM Incorporated, San Diego, CA (US)

(72) Inventors: Jianghong LUO, Skillman, NJ (US); Igor GUTMAN, Hod HaSharon (IL); Konstantinos DIMOU, New York, NY (US); Navid ABEDINI, Basking Ridge, NJ (US); Tao LUO, San Diego, CA (US); Junyi LI, Fairless Hills, PA (US)

(21) Appl. No.: 18/167,009

(22) Filed: Feb. 9, 2023

(51) Int. Cl. H04L 5/00; H04B 7/06

(52) U.S. Cl. CPC H04L 5/0051; H04B 7/0626

(57) ABSTRACT

Various aspects of the present disclosure generally relate to wireless communication. In some aspects, a receive (Rx) node may receive, from a transmit (Tx) node, a reference signal associated with a reference Tx configuration parameter value. The Rx node may obtain a set of channel state information (CSI) values, including respective CSI values for a plurality of Tx configuration parameter values, that are based at least in part on the reference signal associated with the reference Tx configuration parameter value. The Rx node may receive, from the Tx node, a transmission that is associated with a Tx configuration parameter value of the plurality of Tx configuration parameter values based at least in part on the respective CSI values for the plurality of Tx configuration parameter values. Numerous other aspects are described.

### FIELD OF THE DISCLOSURE

Aspects of the present disclosure generally relate to wireless communication and to techniques and apparatuses for channel state information (CSI) enhancement for transmission configuration parameter selection.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a receive (Rx) node. The method includes receiving, from a transmit (Tx) node, a reference signal associated with a reference Tx configuration parameter value. The method includes obtaining a set of channel state information (CSI) values, including respective CSI values for a plurality of Tx configuration parameter values, that are based at least in part on the reference signal associated with the reference Tx configuration parameter value. The method includes receiving, from the Tx node, a transmission that is associated with a Tx configuration parameter value, of the plurality of Tx configuration parameter values, that is based at least in part on the respective CSI values for the plurality of Tx configuration parameter values.

Another aspect provides a method for wireless communication by a Tx node. The method includes transmitting, to an Rx node, an indication of a reference Tx signal quality metric value for a reference signal associated with a reference Tx configuration parameter value and respective Tx signal quality metric values for a plurality of Tx configuration parameter values. The method includes transmitting, to the Rx node, the reference signal using the reference Tx configuration parameter value. The method includes transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, such as wireless communications network of FIG. 1, in accordance with the present disclosure.

FIG. 5A-5C depict examples of power amplifier backoff, in accordance with the present disclosure.

FIGS. 6A-6C are diagrams illustrating examples associated with deriving channel state information (CSI) for different power amplifier backoff values, in accordance with the present disclosure.

FIG. 7 is a diagram illustrating an example associated with CSI enhancement for transmit (Tx) configuration parameter selection, in accordance with the present disclosure.

FIG. 8 is a diagram illustrating an example associated with CSI enhancement for Tx configuration parameter selection, in accordance with the present disclosure.

FIGS. 9A-9C are diagrams illustrating an example associated with CSI enhancement for power amplifier backoff adaptation, in accordance with the present disclosure.

FIGS. 10A-10B are diagrams illustrating an example associated with CSI enhancement for power amplifier backoff adaptation, in accordance with the present disclosure.

FIG. 11 shows a method for wireless communication by an Rx node.

FIG. 12 shows a method for wireless communications by a Tx node.

FIG. 13 is a diagram illustrating an example of an implementation of code and circuitry for a communications device, in accordance with the present disclosure.

FIG. 14 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for channel state information (CSI) enhancement for transmission configuration parameter selection.

Power amplifiers are used in wireless network devices, such as user equipments (UEs) and/or network entities, to increase the power of signals to provide high-quality transmissions. However, power amplifiers may produce non-linear distortions due to a saturation property. At lower input power levels, a power amplifier may operate in a linear region, in which there is a linear (or approximately linear) relationship between the input power level and an output power level of the power amplifier. At higher input power levels, as the power amplifier approaches a saturation point, the power amplifier may experience non-linear distortion and operate in a non-linear region, in which there is a non-linear relationship between the input power level and the output power level.

Power amplifier non-linear distortion (e.g., resulting from operating at or near the saturation point) may cause interference both in the frequency band of a transmitted signal (e.g., in-band interference) and in adjacent/neighboring frequency channels/bands (e.g., out-of-band interference). The in-band interference caused by the power amplifier non-linear distortion may degrade the link performance (e.g., block error rate (BLER)), while the out-of-band interference may adversely affect communications between wireless network devices operating in the adjacent frequency channels and/or in neighboring cells.

To reduce the effects of non-linear distortion on both in-band interference and out-of-band interference, a network entity may apply a power amplifier backoff to control the power amplifier to operate in, or close to, the linear region. In some cases, “power amplifier backoff” may refer to an amount by which the input power level of a power amplifier is reduced. For example, the power amplifier backoff may be subtracted from the input power level at the saturation point, or the power amplifier backoff may be subtracted from an input power level having a maximum efficiency. The power amplifier backoff may be applied to reduce the input power level such that an average input power level of the power amplifier is in, or close to, the linear region. This may ensure that the power amplifier stays in, or close to, the linear region even if there is a slight increase or fluctuation in the input power level. In some cases, “power amplifier backoff” may refer to the corresponding amount that the output power of the power amplifier is reduced (e.g., as compared to a maximum power level of the power amplifier).

A power amplifier backoff may result in a tradeoff between power efficiency and interference reduction. For example, a larger power amplifier backoff may reduce interference and/or error vector magnitude (EVM) distortion due to power amplifier non-linearity, but may also result in reduced power amplifier efficiency, which may potentially degrade the link performance for a transmission. A smaller power amplifier backoff may lead to better power amplifier efficiency, as compared to a larger power amplifier backoff. However, a smaller power amplifier backoff may increase signal distortion (e.g., EVM distortion), which may decrease coverage for a transmission and/or a maximum achievable data rate for the transmission.

In some cases, an optimization process may be used to determine an optimal power amplifier backoff that balances power efficiency and link performance. This optimization process is referred to as power amplifier backoff adaptation. In some examples, different power amplifier backoffs may be used for data transmission at different channel conditions. CSI values corresponding to different power amplifier backoff values may be different for a given channel condition. Accordingly, it may be beneficial to utilize CSI values corresponding to different power amplifier backoff values for power amplifier backoff adaptation.

In one possible approach, a UE may be configured with multiple CSI measurement and report configurations, each for a different power amplifier backoff value. The power amplifier backoff value associated with each configuration may be known by a network node, but may not be known to the UE. However, this approach uses a large signaling overhead and consumes a large amount of network resources because the quantity of channel state information reference signal (CSI-RS) resources and configurations scales with the quantity of power amplifier backoff values. In another possible approach, a ULE may be configured with a single CSI measurement/report configuration at a given power amplifier backoff value, but maintain separate link adaptation loops at the network node for different power amplifier backoff values. For example, the network node may adjust modulation and coding scheme (MCS) values separately for different power amplifier backoff values based on ACK/NACK feedback. However, this may have a slow convergence time, and therefore may not be effective for bursty traffic in a dynamic environment.

In some aspects described herein, a receive (Rx) node may receive a reference signal that is transmitted with a reference transmit (Tx) configuration parameter value, such as a reference power amplifier backoff value. The receive node may obtain CSI values for a plurality of other Tx configuration parameter values (e.g., other power amplifier backoff values) based at least in part on the reference signal. Furthermore, in some aspects, described herein, the Rx node may report a set of CSI values for different Tx configuration parameter values, such as different power amplifier backoff values, to a Tx node. The Tx node may select a Tx configuration parameter value, such as a power amplifier backoff value, for a transmission to the Rx node, based at least in part on the reported set of CSI values, and the Tx node may transmit the transmission to the Rx node using the selected Tx configuration parameter.

As a result, CSI for various power amplifier backoff values, or other Tx configuration parameter values, can be used for power amplifier backoff adaptation, which may result in improved power efficiency and reduced EVM distortion for transmissions. Furthermore, the CSI values for different power amplifier backoff values and/or other Tx configuration parameter values may be obtained using a measurement of a single reference signal, which reduces signaling overhead and network resource utilization, as compared to an approach in which measurements are configured for multiple reference signals transmitted with different power amplifier backoff values.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

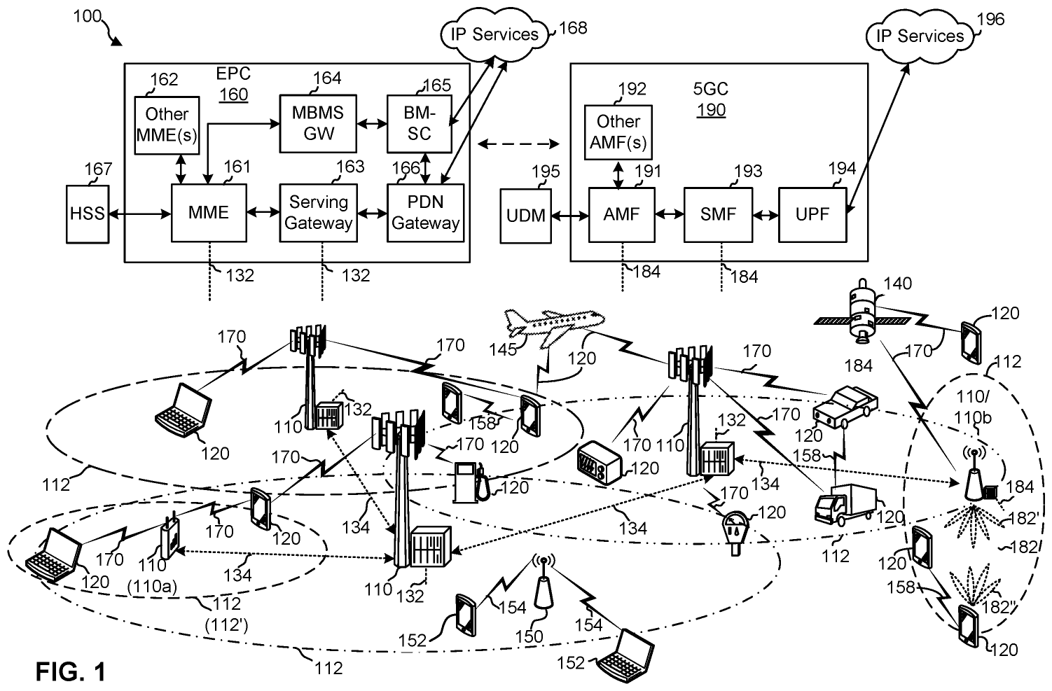

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

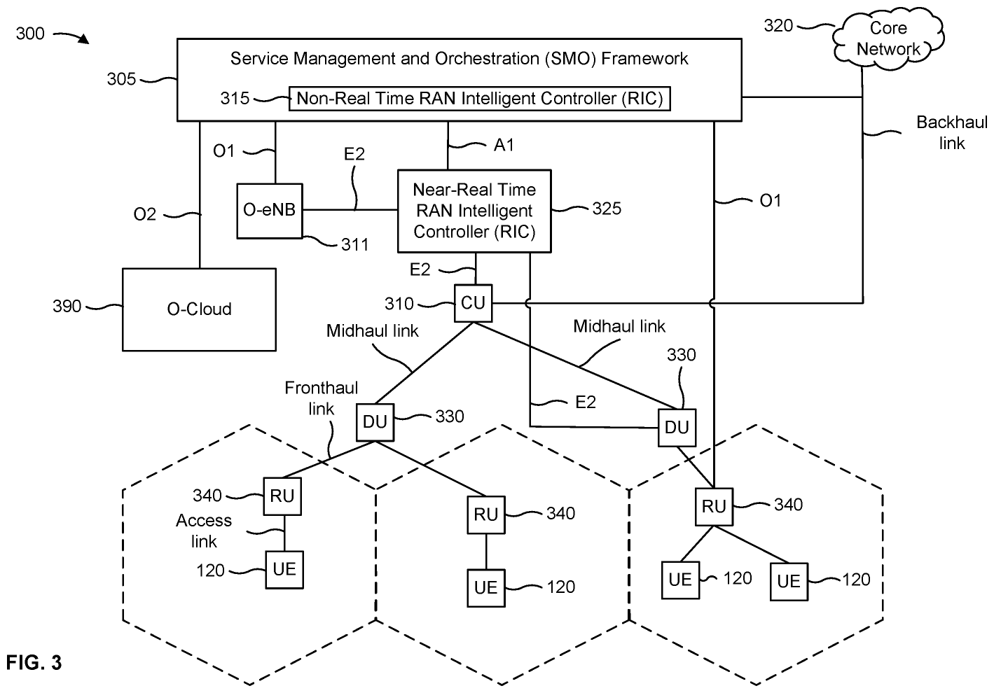

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network (RAN) architecture, such as an Open RAN (O-RAN) architecture or a Virtualized RAN (vRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

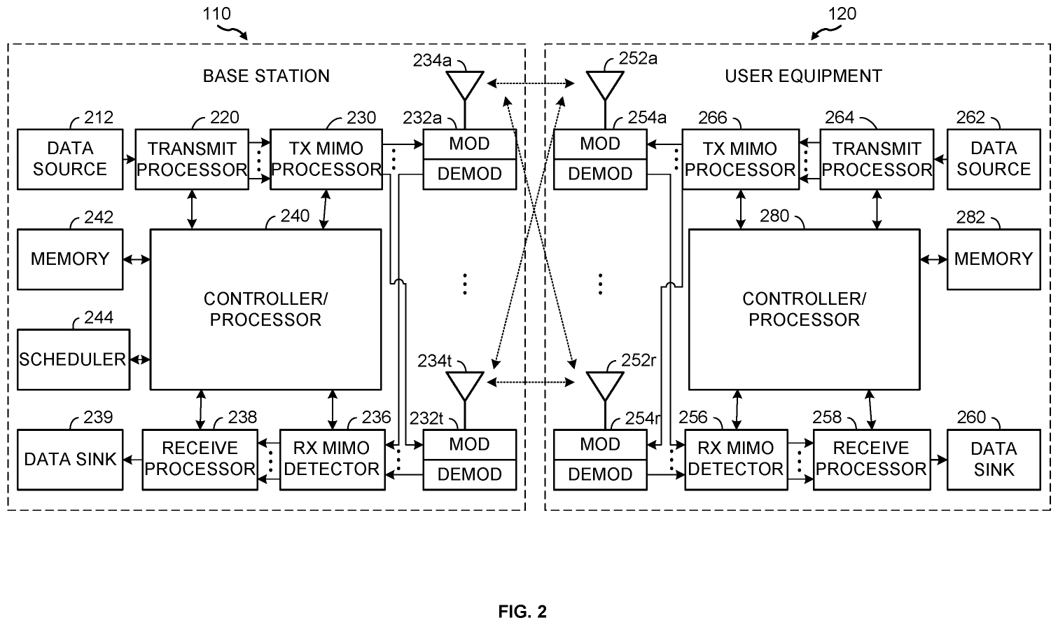

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the CSI-RS.

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

Receive (RX) MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an O-RAN (such as the network configuration sponsored by the O-RAN Alliance), or a vRAN (also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture, in accordance with the present disclosure. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

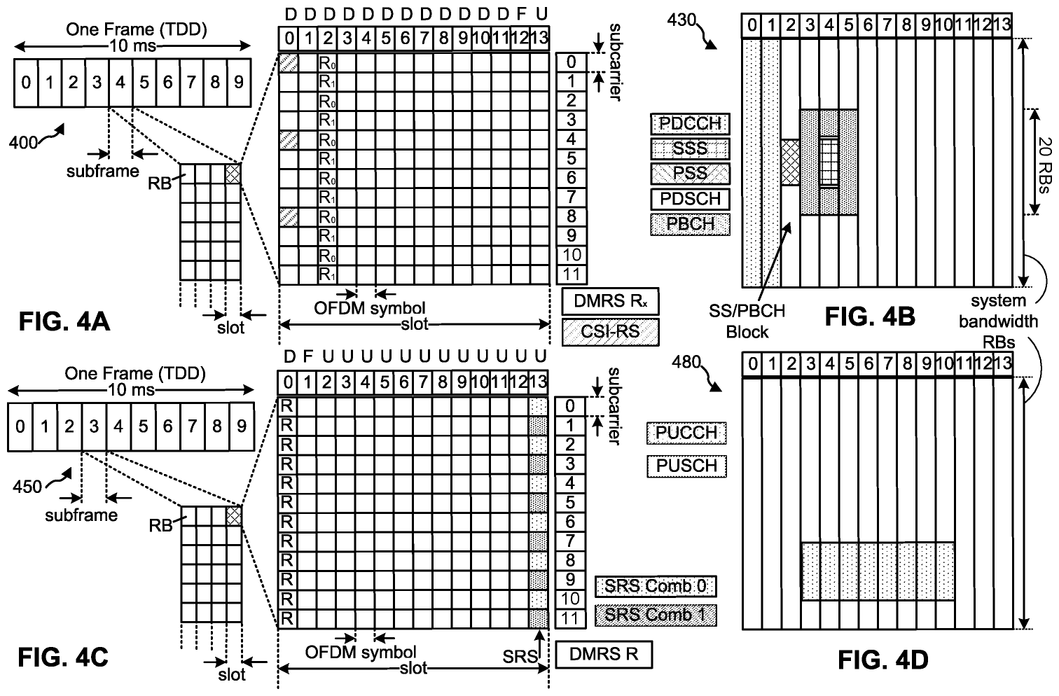

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 29 slots/subframe. The subcarrier spacing and symbol length/duration are a function of the numerology. The subcarrier spacing may be equal to 2^{μ}×15 kHz, where is the numerology index, which may be selected from values 0 to 5. Accordingly, the numerology p=0 has a subcarrier spacing of 15 kHz and the numerology p=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

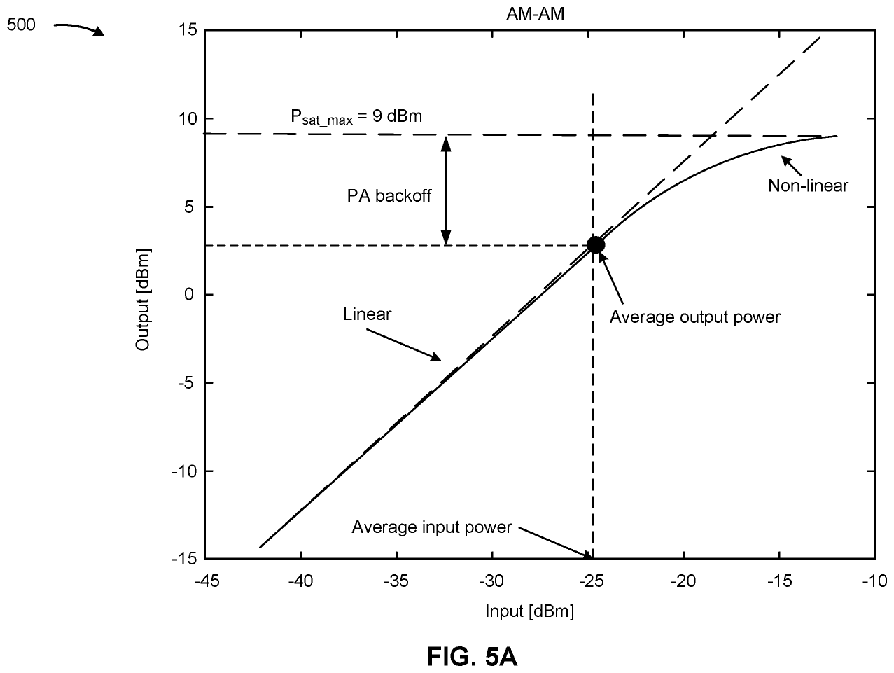

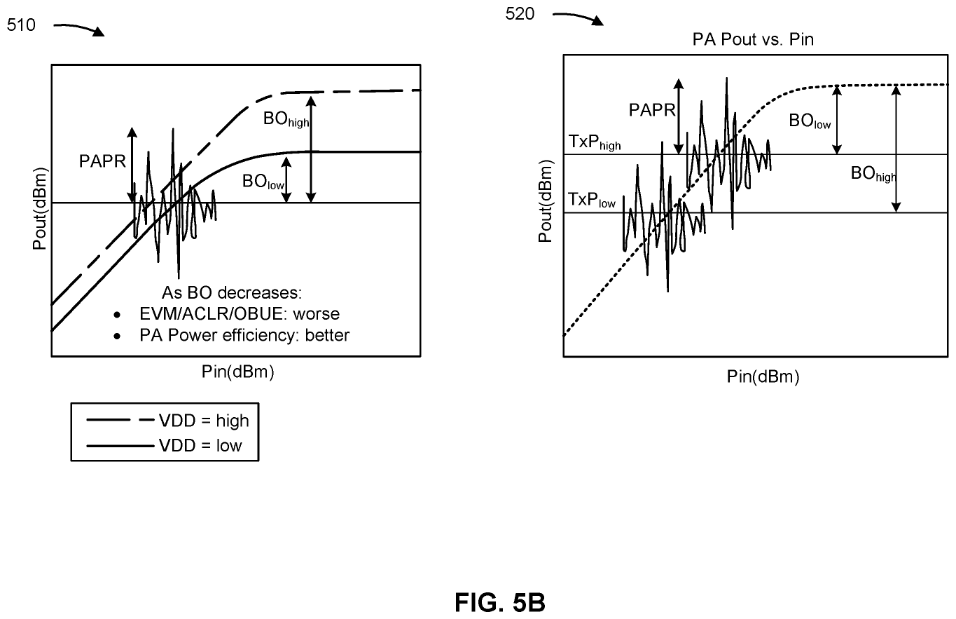

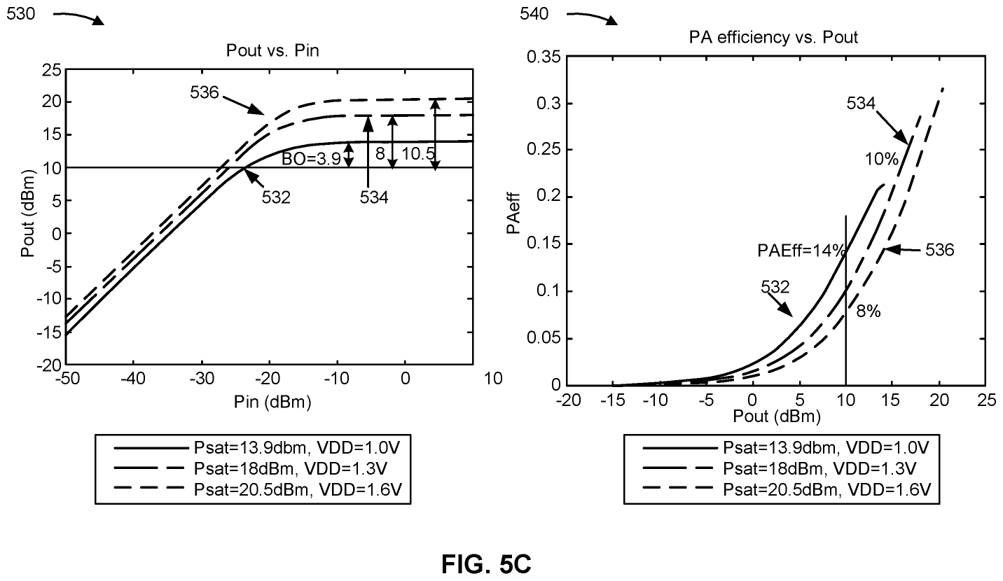

FIGS. 5A-5C depict examples of power amplifier backoff, in accordance with the present disclosure. As shown in FIG. 5A, example 500 depicts an amplitude-to-amplitude (AM-AM) modulation characteristic of a power amplifier of a network entity (e.g., a BS 110) and/or a UE 120.

Power amplifiers are used in wireless network devices, such as UEs and network entities, to increase the power of signals to provide high-quality transmissions. However, power amplifiers may produce non-linear distortions due to a saturation property. As shown in FIG. 5A, at lower input power levels, a power amplifier may operate in a linear region, in which there is a linear (or approximately linear) relationship between the input power level and an output power level of the power amplifier. At higher input power levels, as the power amplifier approaches a saturation point, the power amplifier may experience non-linear distortion and operate in a non-linear region, in which there is a non-linear relationship between the input power level and the output power level. For example, in the non-linear region, as the input power level is increased, the output power level may approach a maximum saturation power level (e.g., max output power). The saturation point may correspond to a point at which a difference between an ideal linear output power level and the actual output power level satisfies a threshold (e.g., 3 dBm or another value).

Power amplifier non-linear distortion (e.g., resulting from operating at or near the saturation point or max output power) may cause interference both in the frequency band of a transmitted signal (e.g., in-band interference) and in adjacent/neighboring frequency channels/bands (e.g., out-of-band interference). The in-band interference caused by the power amplifier non-linear distortion may degrade the link performance (e.g., BLER), while the out-of-band interference may adversely affect communications between wireless network devices operating in the adjacent frequency channels. In some examples, in order to reduce interference with wireless communication devices operating in the adjacent channels, a spectrum emission mask, which imposes a power limit on the adjacent channels, may be applied.

In some examples, in order to reduce the effects of non-linear distortion on both in-band interference and out-of-band interference, a power amplifier backoff may be applied to control the power amplifier to operate in, or close to, the linear region. “Power amplifier backoff” may refer to an input power amplifier backoff or an output power amplifier backoff. An input power amplifier backoff is an amount by which the input power level of a power amplifier is reduced. For example, the power amplifier backoff may be subtracted from the input power level at the saturation point, or the power amplifier backoff may be subtracted from an input power level having a maximum efficiency. The power amplifier backoff may be applied to reduce the input power level such that an average input power level of the power amplifier is in, or close to, the linear region. This may ensure that the power amplifier stays in, or close to, the linear region even if there is a slight increase or fluctuation in the input power level. Moreover, this may reduce the peak-to-average-power ratio (PAPR) of the power amplifier. As shown in FIG. 5A, the output power amplifier backoff is the corresponding drop in output power when a power amplifier backoff is applied. For example, the power amplifier backoff (e.g., output power amplifier backoff) may be a difference between the output power level of the power amplifier and a maximum output level (e.g., a saturation level) for the power amplifier.

In some cases, a power amplifier backoff may result in a tradeoff between power efficiency and interference reduction. For example, different power amplifier backoffs for a power amplifier may correspond to different EVM values. EVM is a metric for modulation quality. For example, EVM may be defined as:

$$EVM = \sqrt{\frac{{\sum }_{t ∈ T} {\sum }_{f ∈ F ( t )} {\vert {Z}^{′ ( t , f )} - I ( t , f ) \vert}^{2}}{{\sum }_{t ∈ T} {\sum }_{f ∈ F ( t )} {\vert I ( t , f ) \vert}^{2}}}$$

where Z′^{(t, f)}−I(t, f) is a distorted signal and I(t, f) is an ideal signal. EVM may also be expressed as EVM(dB)=20*log 10(EVM). Different modulation schemes may have different minimum EVM requirements. In some examples, EVM at transmission of a signal may define an upper limit to a received signal-to-noise ratio (SNR) for the signal. In some cases, such as in higher frequency bands (e.g., FR2), non-linearity of a power amplifier can cause EVM distortion, which results in a reduced SNR and a reduced achievable data rate for a transmission. A larger power amplifier backoff may reduce EVM distortion due to power amplifier non-linearity, and thus may have to be associated with higher −EVM(dB) values. However, a larger power amplifier backoff may also result in reduced power amplifier efficiency, which may potentially degrade the link performance for a transmission. A smaller power amplifier backoff may result in better power amplifier efficiency, as compared to a larger power amplifier backoff. However, a smaller power amplifier backoff may increase EVM distortion, which may decrease the maximum achievable data rate.

FIG. 5B shows two examples approaches of power amplifier backoff adaptation. As shown by reference number 510, in a first approach, power amplifier backoff adaptation is performed by changing the power amplifier supply voltage (VDD) with a fixed output power amplifier transmission power. That is, the power amplifier saturation power level is changed (e.g., the power amplifier saturation level increases with the power amplifier supply voltage) for a fixed power amplifier power output for a signal. In this approach, a larger power amplifier backoff (BO) value corresponds to a larger power amplifier saturation power level at a higher power amplifier supply voltage, and a lower power amplifier backoff value corresponds to a lower saturation power level at a lower power amplifier supply voltage.

As shown by reference number 520, in a second approach, power amplifier backoff adaptation is performed by changing the output power amplifier transmission power (TxP) with a fixed power amplifier supply voltage. That is the power amplifier power output operation point is changed with a fixed power amplifier supply voltage. In this approach, a larger power amplifier backoff value corresponds to a smaller power amplifier power output (e.g., a lower transmission power), and a lower power amplifier backoff corresponds to a higher power amplifier power output (e.g., a higher transmission power). In both the first approach and the second approach, a larger power amplifier backoff value provides better EVM, adjacent channel leakage ratio (ACLR), operating band unwanted emissions (OBUE), but a at a cost of a lower power efficiency. A smaller power amplifier backoff value provides better power amplifier power efficiency, but worse EVM, ACLR, and OBUE.

FIG. 5C shows an example of different power amplifier backoff values for power amplifier backoff adaptation using the first approach described in connection with reference number 510 of FIG. 5B. As shown by reference number 530, three different options are provided for power amplifier supply voltage and power amplifier backoff power value to achieve a power amplifier output power of 10 dBm. In a first option 532, the power amplifier supply voltage (VDD) is 1.0 V, the power amplifier saturation power level (Psat) is 13.9 dBm, and the power amplifier backoff (BO) value is 3.9 dBm. In a second option 534, the power amplifier supply voltage is 1.3 V, the power amplifier saturation power level is 18 dBM, and the power amplifier backoff value is 8 dBm. In a third option 536, the power amplifier supply voltage is 1.6 V, the power amplifier saturation power level is 18 dBM, and the power amplifier backoff value is 8 dBm. As further shown by reference number 530, for a fixed power amplifier power output (e.g., 10 dBm), the higher the power amplifier backoff value, the more the power amplifier is operating in the linear region, resulting in decreased non-linearity distortion and better EVM, ACLR, and OBUE. As shown by reference number 540, for a fixed power amplifier power output (e.g., 10 dBm), the lower the power amplifier backoff value, the higher the power amplifier efficiency. In the example of FIG. 5C, for a power amplifier power output of 10 dBm, the first option 532 (Psat=13.9 dBm, VDD=1.0 V, BO=3.9 dBm) has a power amplifier efficiency of 14%, the second option 534 (Psat=18 dBm, VDD=1.3 V, BO=8 dBm) has a power amplifier efficiency of 10%, and the third option 536 (Psat=20.5 dBm, VDD=1.6 V, BO=10.5 dBm) has a power amplifier efficiency of 8%.

In some examples, an optimization process may be used to determine an optimal power amplifier backoff that balances power efficiency and EVM distortion. This optimization process may be referred to as power amplifier backoff adaptation. For example, a power amplifier backoff adaptation scheme may select a power amplifier backoff based on w

$$BO * ( h ) = {max}_{B O} \frac{rate ( h , BO )}{Trp / PAEff ( B O )} ,$$

where BO denotes a power amplifier backoff, h denotes a channel (e.g., channel conditions), rate(h, BO) denotes an achievable data rate, Trp denotes a transmit power, and PAEff(BO) denotes a power amplifier efficiency. In such a power amplifier backoff adaptation scheme, different power amplifier backoffs may be used for data transmission at different channel conditions. CSI values (e.g., SNR, CQI, MCS, or rate, among other examples) corresponding to different power amplifier backoff values may be different for a given channel condition. Accordingly, it may be beneficial to utilize CSI values corresponding to different power amplifier backoff values for power amplifier backoff adaptation.

As indicated above, FIGS. 5A-5C are provided as examples. Other examples may differ from what is described with respect to FIGS. 5A-5C.

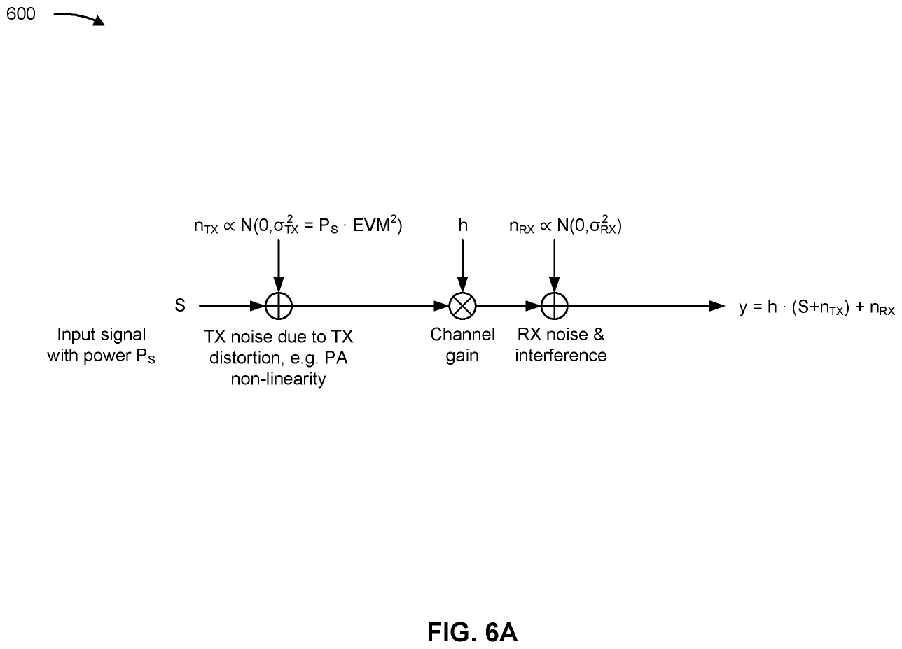

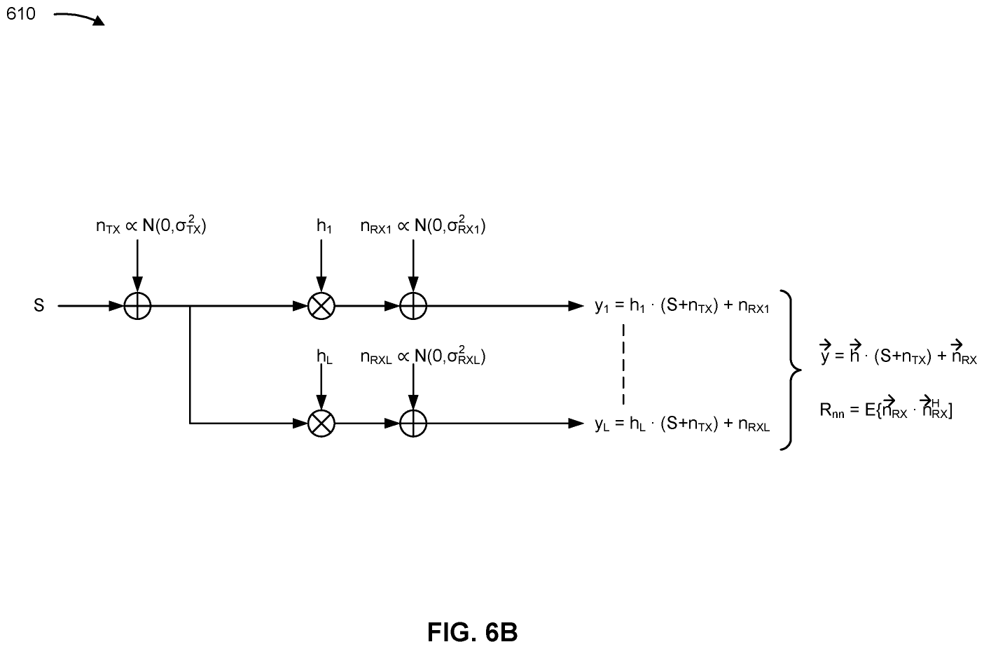

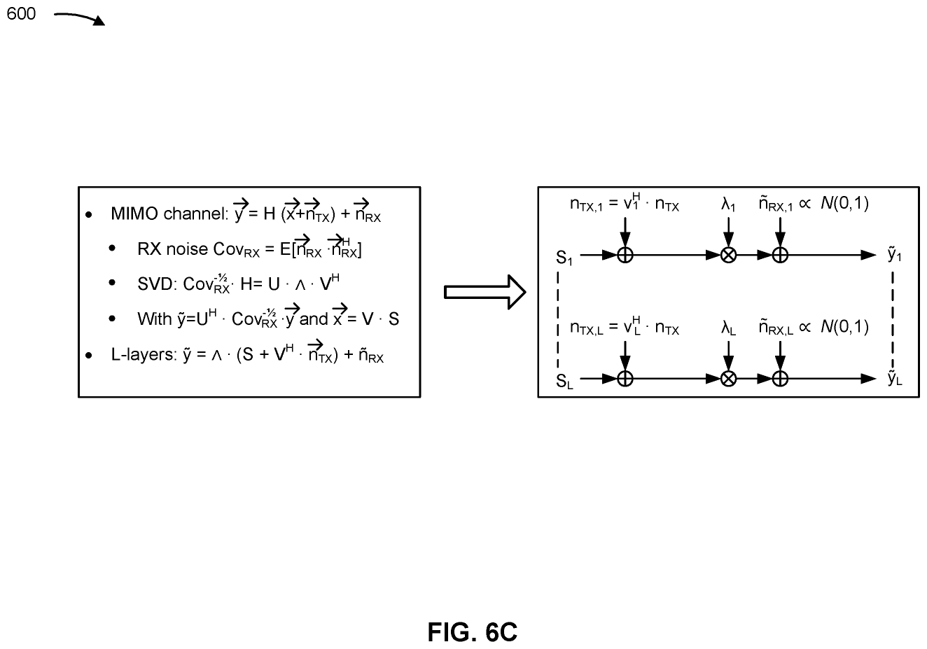

FIGS. 6A-6C are diagrams illustrating examples associated with deriving CSI for different power amplifier backoff values, in accordance with the present disclosure.

In some aspects, an Rx node (e.g., a UE for a downlink transmission or a network node for an uplink transmission) may derive CSI values for multiple different power amplifier backoff values based at least in part on an SNR measurement of a reference signal transmitted using a reference power amplifier backoff value. FIG. 6A shows an example 600 of an additive white Gaussian noise (AWGN) channel model, in which S is an input signal with a power P_{S}, n_{TX} ∝N(0, σ_{TX}²=P_{S}·EVM²) is a Tx noise due to Tx distortion (e.g., due to power amplifier non-linearity), h is a channel gain, n_{RX} ∝N(0, σ_{RX}²) is an Rx noise and interference, and y=h·(S+n_{TX})+n_{RX} is an output signal. In this example, SNR can be determined as:

$$SNR = \frac{{\vert h \vert}^{2} \cdot {P}_{S}}{{\vert h \vert}^{2} \cdot {σ}_{TX}^{2} + {σ}_{RX}^{2}} = \frac{1}{\frac{{σ}_{TX}^{2}}{{P}_{S}} + \frac{{σ}_{RX}^{2}}{{\vert h \vert}^{2} \cdot {P}_{S}}} = \frac{1}{{EVM}^{2} + \frac{{σ}_{RX}^{2}}{{\vert h \vert}^{2} \cdot {P}_{S}}} where EVM = \{ \begin{matrix}{EVM}_{ref} & for reference signal \\ {EVM}_{data} & for data\end{matrix} .$$

The term

$$\frac{{σ}_{R X}^{2}}{{\vert h \vert}^{2} \cdot {P}_{S}}$$

is independent of EVM. The SNR of a reference signal can be determined as

$${SNR}_{ref} = \frac{1}{{EVM}_{ref}^{2} + \frac{{σ}_{R X}^{2}}{{\vert h \vert}^{2} \cdot {P}_{S}}}$$

such that

$$\frac{{σ}_{R X}^{2}}{{\vert h \vert}^{2} \cdot {P}_{S}} = \frac{1}{{SNR}_{ref}} - {EVM}_{ref}^{2} .$$

Thus, the SNR of a data signal can be determined based on the SNR of the reference signal, the EVM of the data signal, and the EVM of the reference signal, as:

$${SNR}_{data} = \frac{1}{{EVM}_{data}^{2} - {EVM}_{ref}^{2} + \frac{1}{{SNR}_{ref}}} ,$$

assuming the channel h and Rx variance σ_{RX}² stay constant.

FIG. 6B shows an example 610 of an AWGN channel model with L Rx paths (e.g., L Rx antennas). In this example, for a minimum mean square error (MMSE) receiver, SNR can be determined as:

$$SNR = {h}^{H} \cdot {( \vec{h} \cdot {\vec{h}}^{H} \cdot {σ}_{TX}^{2} + {R}_{nn} )}^{- 1} \cdot h \cdot {P}_{S} = \frac{1}{\frac{{σ}_{TX}^{2}}{{P}_{S}} + \frac{1}{{h}^{H} \cdot {R}_{nn}^{- 1} \cdot h} \cdot \frac{1}{{P}_{S}}}$$

using the matrix inversion formula. In this case,

$${SNR}_{data} = \frac{1}{{EVM}_{data}^{2} - {EVM}_{ref}^{2} + \frac{1}{{SNR}_{ref}}}$$

holds for any channel with

$$SNR = \frac{1}{EVM + x} ,$$

where x is independent of Tx EVM. This property holds for many different types of receiver implementations (e.g., an MMSE receiver (as shown in this example) or a zero-forcing receiver, among other examples).

FIG. 6C shows an example 620 of an AWGN channel model with L MIMO layers. In this example, an equivalent L-layer model is given by \tilde{y}ⱼ=λᵢ·(Sᵢ+vᵢ^{H}·\vec{n}_{TX})+ñ_{RX,i}. A lower bound of achievable rate across L layers is given by:

$$r ( {SNR}_{data} ) \geq {\sum }_{i = 1}^{L} r ( {SNR}_{data , i} ) , {SNR}_{data , i} = \frac{1}{{EVM}_{data , i}^{2} - {EVM}_{ref , i}^{2} + \frac{1}{{SNR}_{ref , i}}}$$

where equality is achieved when ñ_{TX,i} for the L layers are treated as independent noise by the receiver. The Tx EVM for the i-th layer is

$${EVM}_{i}^{2} = \frac{{\vec{v}}_{i}^{H} \cdot {Cov}_{TX} \cdot {\vec{v}}_{i}}{{P}_{S , i}} ,$$

where Cov_{TX} is a noise covariance matrix across the Tx antennas. If the Tx antenna noise is independent across the different Tx antennas, then

$$\frac{{Cov}_{TX}}{{P}_{S , i}} = diag ( {PA\_EVM}_{1}^{2} , … , {PA\_EVM}_{N}^{2} ) ,$$

where PA_EVMⱼ is the EVM for the j-th Tx antenna due to power amplifier backoff. If PA_EVMⱼ=PA_EVM for all Tx antennas, then EVMᵢ²=PA_EVM² and ñ_{TX,i} are independent.

In some aspects, as discussed above in connection with FIGS. 6A-6C, an SNR value of a data signal (SNR_{data}) associated with a power amplifier backoff value can be derived from an SNR measurement (SNR_{ref}) of a reference signal with a reference power amplifier backoff value, an EVM for the reference power amplifier backoff value (EVM_{ref}), and an EVM for the power amplifier backoff associated with the signal (EVM_{data}), as

$${SNR}_{data} = \frac{1}{{EVM}_{data}^{2} - {EVM}_{ref}^{2} + \frac{1}{{SNR}_{ref}}} .$$

Note that

$${SNR}_{data} < \frac{1}{{EVM}_{data}^{2}} and {SNR}_{ref} < \frac{1}{{EVM}_{ref}^{2}} .$$

If EVM_{data}=EVM_{ref}, then SNR_{data}=SNR_{ref}. If EVM_{data}<EVM_{ref}, then

$${SNR}_{ref} < {SNR}_{data} < \frac{1}{{EVM}_{data}^{2}} .$$

If EVM_{data}>EVM_{ref}, then

$${SNR}_{data} < min ( {SNR}_{ref} , \frac{1}{{EVM}_{data}^{2}} ) .$$

In some aspects, EVM_{ref} and EVM_{data} may be known by a Tx data node, and SNR_{ref} may be known (or measured) by an Rx node. In case of channel variation, SNR_{ref} may be replaced with SNR_{ref}·α(delay, doppler), where a(delay, doppler) is estimated using multiple reference signals. In some aspects, if the calculation of SNR_{data} is performed at an Rx node, EVM may be indicated from a Tx node to the Rx node. In some aspects, if the calculation of SNR_{data} is performed at the Tx node, SNR_{ref} may be indicated from the Rx node to the Tx node. In some cases, SNR to rate mapping may depend on an implementation of the Rx node, and may not be available at the Tx node. In some aspects, if the scheduling node is the Rx node (e.g., a network node for an uplink communication), the Tx node may indicate some cost metric values for different power amplifier backoff values. For example, the cost metric values may be power consumption values or indicators associated with different power amplifier backoff values. For example, a power consumption value for a power amplifier backoff value may be a relative value that is relative to the power consumption for the reference signal.

As indicated above, FIGS. 6A-6C are provided as an example. Other examples may differ from what is described with respect to FIGS. 6A-6C.

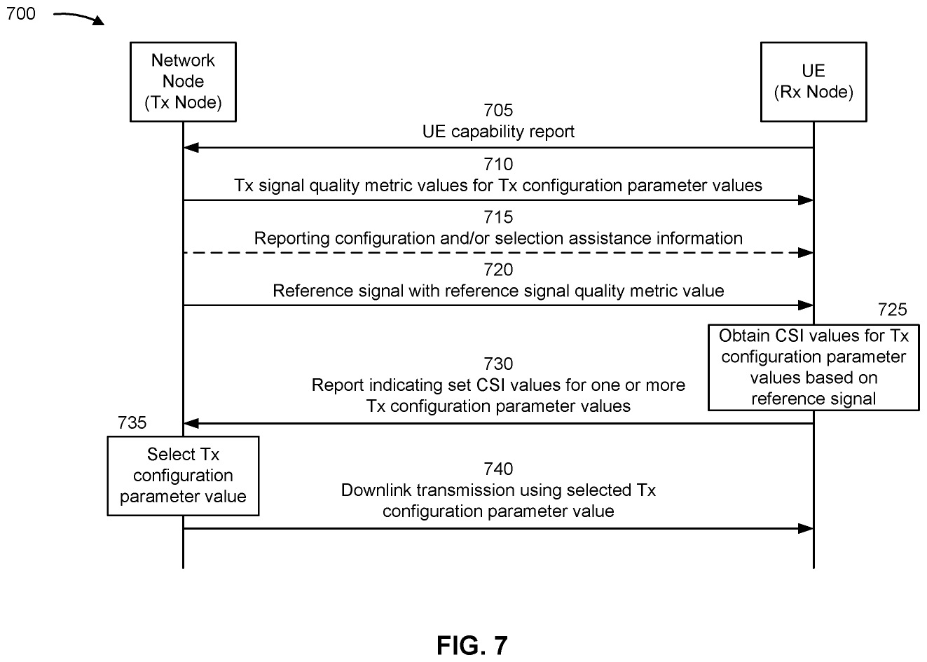

FIG. 7 is a diagram illustrating an example 700 associated with CSI enhancement for Tx configuration parameter selection, in accordance with the present disclosure. As shown in FIG. 7, example 700 includes communication between a network node (e.g., BS 110 or a disaggregated base station as discussed with respect to FIG. 3) and a UE (e.g., UE 120). In some aspects, the network node and the UE may be included in a wireless network, such as wireless network 100. The network node and the UE may communicate via a wireless access link, which may include an uplink and a downlink.

As shown in FIG. 7, example 700 is associated with CSI enhancement for Tx configuration parameter selection or adaptation for downlink communication. In example 700, the network node is a Tx node for transmitting a downlink communication, and the UE is an Rx node for receiving the downlink communication. In this case, the Tx node (e.g., the network node) is a scheduling node for the downlink communication, and the Rx node (e.g., the UE) is a scheduled node for the downlink communication. In some aspects, the enhanced CSI framework discussed in connection with FIG. 7 may be used for power amplifier backoff adaptation to select a power amplifier backoff to be used by network node for downlink transmission. In some other aspects, the enhanced CSI framework discussed in connection with FIG. 7 may be used for selection or adaptation of another Tx configuration parameter for downlink transmission, such as a Tx power value, a digital-to-analog converter (DAC) resolution, or a crest factor reduction (CFR) parameter, among other examples.

As shown in FIG. 7, and by reference number 705, the UE (e.g., the Rx node) may transmit, and the network node (e.g., the Tx node) may receive, a UE capability report. The UE capability report may include an indication of a UE capability for deriving a set of CSI values for different Tx configuration parameter values based on a reference signal associated with a reference Tx configuration parameter value. In some aspects, the indication of the UE capability may include an indication of a preferred reference Tx signal quality metric value for the reference signal to be used for deriving the set of CSI values. In one example, the preferred Tx signal quality metric value may be a preferred reference EVM value (EVM_{ref}) for the reference signal. In this case, the preferred EVM value may correspond to a preferred reference Tx configuration parameter value (e.g., a preferred reference power amplifier backoff) to be used for transmitting the reference signal. In some other examples, the preferred reference Tx signal quality metric value may be a preferred reference value for another Tx signal quality metric (e.g., Tx SNR or maximum achievable data rate) associated with a preferred reference Tx configuration parameter to be used for transmitting the reference signal.

As further shown in FIG. 7, and by reference number 710, the network node (e.g., the Tx node) may transmit, and the UE (e.g., the Rx node) may receive an indication of respective Tx signal quality metric values for a plurality of Tx configuration parameter values. The plurality of Tx configuration parameter values may include different possible values for a Tx configuration parameter to be used to transmit a downlink communication. In some aspects, each Tx configuration parameter value may be associated with a different Tx distortion. For example, the Tx configuration parameter values may include different possible power amplifier backoff values, Tx power values (or Tx power offset values), DAC resolutions, or CFR parameter values. In some aspects, the Tx configuration parameter values may include a reference Tx configuration parameter value to be used to transmit a reference signal and one or more other Tx configuration parameter values, different from the reference Tx configuration parameter value, that are possible values to be used to transmit a downlink communication.

In some aspects, the network node may transmit, and the UE may receive, an indication of the reference Tx configuration parameter value for the reference signal and other Tx configuration parameter values for which CSI values are to be derived based on the reference signal transmitted with the reference Tx configuration parameter value. In one example (e.g., for power amplifier backoff adaptation), the network node may indicate a reference power amplifier backoff value to be used for transmitting the reference signal and one or more other power amplifier backoff values for which CSI values are to be derived by the UE. In another example (e.g., for Tx power selection in a variable Tx power scheme), the network node may indicate a reference Tx power value to be used for transmitting the reference signal and other Tx power values for which CSI values are to be derived. In some aspects, the network node may transmit the indication of the Tx configuration parameter values together with, or independent from, the Tx signal quality metric values for the Tx configuration parameter values.

In some aspects, the respective Tx signal quality metric values, for the Tx configuration parameter values, may be values of a Tx signal quality metric. For example, the Tx signal quality metric may be EVM, Tx SNR, or a maximum achievable rate limit. The Tx signal quality metric value, for each Tx configuration parameter value, may be a value for the Tx signal quality metric corresponding to the Tx configuration parameter that is known (e.g., stored) or obtained (e.g., determined, derived, calculated, identified, received, or acquired) by the Tx node (e.g., the network node). For example, different power amplifier backoff values may be mapped to respective EVM values that correspond to the upper limits to received SNR for the different power amplifier backoff values. The Tx signal quality metric values may include a reference Tx signal quality metric value for a reference Tx configuration parameter value (e.g., for the reference signal) and respective Tx signal quality metric values for the Tx configuration parameter values other than the reference Tx configuration parameter value. In some aspects, indication of the Tx signal quality metric values may include an indication of the reference Tx signal quality metric value and the respective Tx signal quality metric values for the Tx configuration parameter values other than the reference Tx configuration parameter value. In one example, in a case in which the Tx configuration parameter values are power amplifier backoff values, the Tx signal quality metric values may include a reference EVM (EVM_{ref}) for the reference power amplifier backoff to be used to transmit the reference signal and EVM values (EVM₁, . . . , EVM_{N}) for the power amplifier backoff values other than the reference power amplifier backoff value.

As further shown in FIG. 7, and by reference number 715, the network node (e.g., the Tx node) may transmit, and the UE (e.g., the Rx node) may receive, a reporting configuration and/or selection assistance information. The reporting configuration may configure reporting of CSI values derived/obtained for all or a subset of the Tx configuration parameter values. The selection assistance information may include information to assist the UE in selecting which CSI values, of a set of CSI values derived for the Tx configuration parameter values, to report.

In some aspects, the reporting configuration may indicate one or more triggering conditions for reporting CSI values for the Tx configuration parameter values. For example, the one or more triggering conditions may include a triggering condition that triggers reporting of the CSI values when one or more CSI values for Tx configuration parameter values other than the reference Tx configuration parameter value are significantly different than a baseline CSI value for the reference signal. In this case, the triggering condition may be satisfied in connection with a difference between a respective CSI value for at least one Tx configuration parameter value of the plurality of Tx configuration parameter values and a baseline CSI value for the reference signal satisfying a threshold. Additionally, or alternatively, the one or more triggering conditions may include a configuration of periodicity for periodic reporting of the CSI values.

In some aspects, the reporting configuration may indicate a selection criterion for selecting the CSI values for the Tx configuration parameter values to be reported (e.g., to be included in a report transmitted by the UE). In some aspects, the selection criterion may indicate one or more selected Tx configuration parameter values, of the plurality of Tx configuration parameter values, for which to report the respective CSI values. In this case, the UE may report (e.g., may include in the report) only the respective CSI values associated with the one or more selected Tx configuration parameter values indicated by the selection criterion. In some aspects, the selection criterion may indicate that CSI values that are within a range of the baseline CSI value for the reference signal are to be reported. In this case, the UE may include in the report any CSI values, for the Tx configuration parameter values, that are within the range of the baseline CSI value for the reference signal. In some aspects, the selection criterion may indicate that CSI values that are outside of a range of the baseline CSI value for the reference signal are to be reported. In this case, the UE may include in the report any CSI values, for the Tx configuration parameter values, that are outside of the range of the baseline CSI value for the reference signal.

In some aspects, the selection criterion may indicate a quantity of CSI values to be included in the report. For example, the selection criterion may indicate for the UE to report a top (e.g., best) M CSI values out of the N Tx configuration parameter configuration values. In some aspects, the selection assistance information may include cost metric information to assist the UE with selecting which CSI values (e.g., the top M CSI values) to report. For example, the cost metric information may include respective cost metric values for the plurality of Tx configuration parameter values, and the UE may select the indicated quantity (e.g., the top N) of the CSI values for the Tx configuration parameter values based at least in part on the respective cost metric values for the Tx configuration parameter values. In some aspects, the respective cost metric value for each Tx configuration parameter value may be indicative of a Tx energy consumption for the Tx configuration parameter value. In some examples, the cost metric values may be absolute values for a Tx energy consumption metric or relative values with respect to the reference signal. For example, for a power amplifier backoff value, a relative cost metric value may be a ratio of a power amplifier efficiency for the power amplifier backoff value to a power amplifier efficiency of the reference power amplifier backoff value used for transmitting the reference signal. In this case, the cost metric for each power amplifier backoff value may be a relative power amplifier efficiency value, expressed as:

$$relativePAEff ( {BO}_{i} ) = \frac{PAEff ( {BO}_{i} )}{PAEff ( {BO}_{ref} )} ,$$

where BOᵢ denotes a power amplifier backoff value, BO_{ref} denotes the reference power amplifier backoff value, and PAEff denotes the power amplifier efficiency.

As further shown in FIG. 7, and by reference number 720, the network node (e.g., the Tx node) may transmit, and the UE (e.g., the Rx node) may receive, a reference signal associated with the reference signal quality metric value (e.g., a reference signal associated with the reference Tx configuration parameter value). That is, the network node may transmit the reference signal using the reference Tx configuration parameter value (e.g., the Tx configuration parameter value associated with the reference Tx signal quality metric value). For example, the reference signal may be a CSI-RS, or another downlink reference signal. In one example, in a case in which the Tx configuration parameter values are different power amplifier backoff values, the network node may transmit the reference signal using the reference power amplifier backoff value. In another example, in a case in which the Tx configuration parameter values are different Tx powers, the network node may transmit the reference signal using the reference Tx power.

As further shown in FIG. 7, and by reference number 725, the UE (e.g., the Rx node) may obtain CSI values for the Tx configuration parameter values that are based at least in part on the reference signal associated with (e.g., transmitted using) the reference Tx configuration parameter. As used herein, “obtaining” the CSI values may include deriving, determining, calculating, identifying, receiving, or acquiring the CSI values, or any combination thereof. In some aspects, the UE may derive a set of CSI values, that includes respective CSI values for the plurality of Tx configuration parameter values, based at least in part on a measurement (e.g., an SNR measurement) of the reference signal transmitted using the reference Tx configuration parameter value. For example, the respective CSI values, for the plurality of Tx configuration parameter values, may include respective CQI values, MCS values, signal-to-interference-plus-noise ratio (SINR) values, SNR values, or data rate values, among other examples. In some aspects, the UE may derive the respective CSI values for the plurality of Tx configuration parameter values based at least in part on the respective Tx signal quality metric values for the plurality Tx configuration parameter values, the reference Tx signal quality metric value, and the measurement (e.g., SNR measurement) of the reference signal.

In some aspects (e.g., in a case in which the Tx configuration parameter values are power amplifier backoff values), the Tx signal quality metric values may be EVM values. That is, the reference Tx signal quality metric value may be a reference EVM value (EVM_{ref}), and the respective Tx signal quality metric values for the plurality of Tx configuration parameter values (e.g., power amplifier backoff values) may be respective EVM values (EVM₁, . . . , EVM_{N}). In this case, the UE may derive respective SNR values for the plurality of Tx configuration parameter values (e.g., power amplifier backoff values) based at least in part on the respective EVM values (EVM₁, . . . , EVM_{N}), the reference EVM value (EVM_{ref}), and a measured SNR value (SNR_{ref}) of the reference signal. For example, the UE may determine the respective SNR value (SNR_{data}) for each Tx configuration parameter value (e.g., for each power amplifier backoff value) as

$${SNR}_{data} = \frac{1}{{EVM}_{data}^{2} - {EVM}_{ref}^{2} + \frac{1}{{SNR}_{ref}}} .$$

In some aspects, the respective CSI values for the Tx configuration parameter values may include the respective SNR values derived for the Tx configuration parameter values. In some aspects, the UE may determine another respective CSI value (or CSI values) for each Tx configuration parameter value (e.g., each power amplifier backoff value) based at least in part on the respective SNR value (SNR_{data}) for each Tx configuration parameter value.

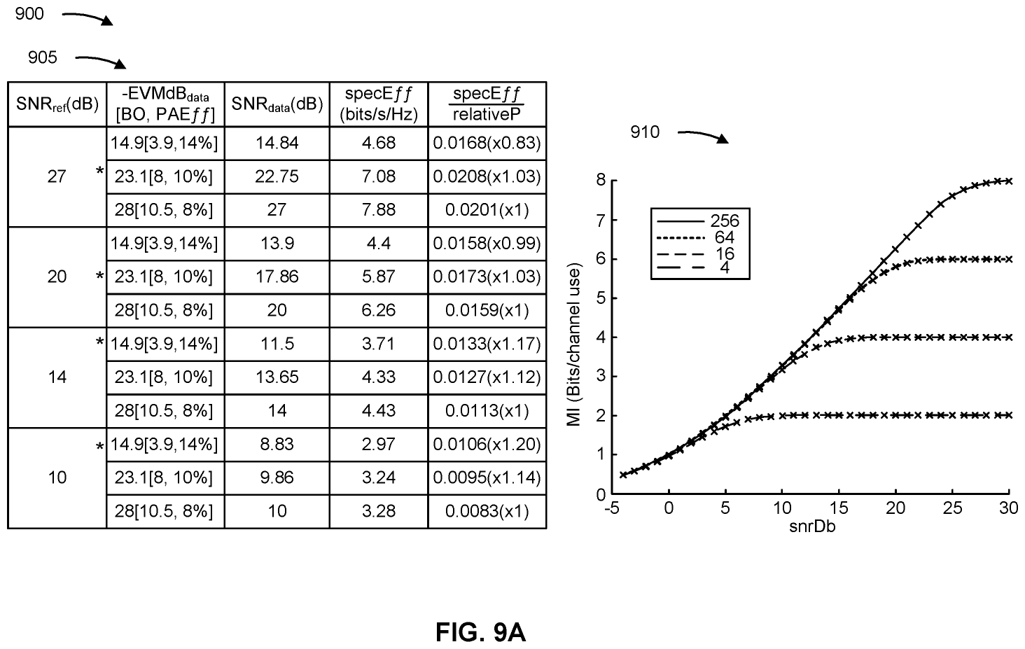

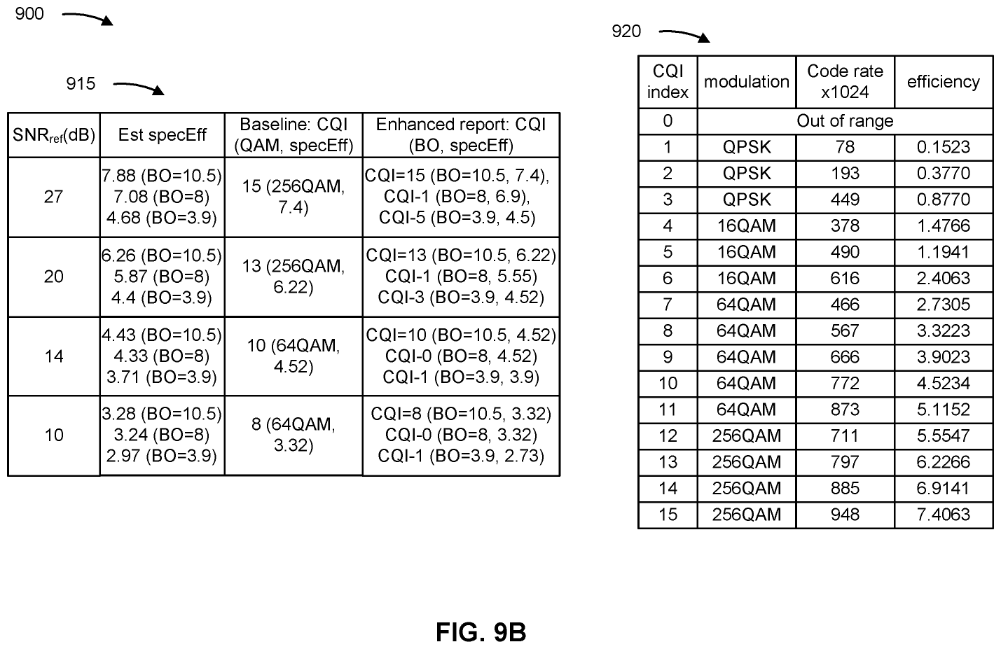

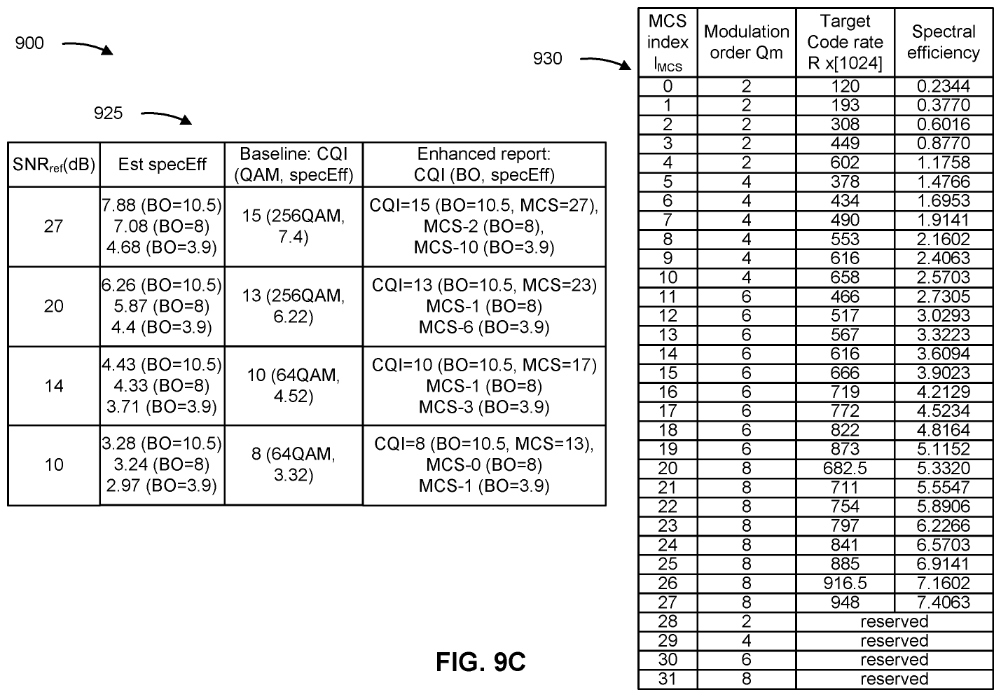

In some aspects, in a case in which the Tx configuration parameter values are power amplifier backoff values, the UE may determine a respective CQI value or a respective MCS value for each power amplifier backoff value based at least in part on the respective SNR value (SNR_{data}) derived for each power amplifier backoff value. In this case, the UE may determine a respective spectral efficiency based on the derived SNR value (SNR_{data}) for each power amplifier backoff value, for example, based at least in part on a mapping between SNR and spectral efficiency (e.g., as shown in FIG. 9A). The UE may determine a respective CQI value based on the spectral efficiency for each power amplifier backoff, for example, using a mapping between CQI and spectral efficiency (e.g., as shown in FIG. 9B), or the UE may determine a respective MCS value based on the spectral efficiency for each power amplifier backoff, for example, using a mapping between MCS and spectral efficiency (e.g., as shown in FIG. 9C). In some aspects, the UE may derive SNR values and/or determine CQI, MCS, or other CSI values based on derived SNR values, for other types of Tx configuration parameter value similarly to as described for power amplifier backoff values.

In some aspects, in a case in which the Tx configuration parameter values are different Tx power values, the UE may derive achievable data rates for the different power values based at least in part on a measurement of the reference signal transmitted using a reference Tx power. In this case, an SNR value for a Tx power value (P_{data}) may be derived as a scaled value of the measured SNR value for the reference signal transmitted at the reference Tx power (P_{ref}). For example, for each Tx power value (P_{data}), the UE may derive the respective SNR value as

$$SNR ( {P}_{data} ) = \frac{{P}_{data}}{{P}_{ref}} .$$

$$SNR ( {P}_{ref} ) .$$

The UE may then determine a respective achievable data rate, rate(SNR(P_{data})), for each Tx power value (P_{data}), based on a mapping of SNR to rate. In this case, a set of CSI values reported for the different Tx power values may include the respective achievable data rates derived for one or more of the different Tx power values.

As further shown in FIG. 7, and by reference number 730, the UE (e.g., the Rx node) may transmit, and the network node (e.g., the Tx node) may receive, a report indicating a set of CSI values including respective CSI values for one or more Tx configuration parameter values, of the plurality of Tx configuration parameter values. The UE may transmit the report in accordance with the reporting configuration. For example, the UE may transmit the report in connection with at least one triggering condition, indicated in the reporting configuration, being triggered.

The UE may include, in the report, respective CSI values for all of the plurality of Tx configuration parameter values or for a subset of the plurality of Tx configuration parameter values. In some aspects, the UE may select the CSI values to include in the report based at least in part on the selection criterion indicated in the reporting configuration. For example, the UE may determine for which Tx configuration parameter values, of the plurality of Tx configuration parameter values, to include the respective CSI values in the report. In some aspects, in a case in which the selection criterion indicates to report the top N CSI values, the UE may select the top N CSI values, from the respective CSI values for the plurality of Tx configuration parameter values, based at least in part on the respective cost metric values for the plurality of Tx configuration parameter values. For example, for each power amplifier backoff value, the respective cost metric value may be a respective power amplifier efficiency value or a respective relative power amplifier efficiency with respect to the reference signal

$$( e . g . , relativePAEff ( {BO}_{i} ) = \frac{PAEff ( {BO}_{i} )}{PAEff ( {BO}_{ref} )} ) .$$

In is case, the UE may determine a respective relative power consumption value (relativeP) for each power amplifier backoff value using a power consumption evaluation model for power amplifier backoff:

$$relativeP = {P}_{0} + {S}_{a} \cdot ( {P}_{active} - {P}_{0} ) \cdot ( ( 1 - A ) + \frac{{S}_{p} \cdot {S}_{f} \cdot A}{relativePAEff ( B {O}_{i} )} ) .$$

The parameters of the power consumption evaluation model may be set in accordance with a wireless communication standard. In one examples, the parameters of the power consumption evaluation model may be set as P₀=25, P_{active}=152, A=0.6, Sₚ=1, S_{f}=1, and Sₐ=2. The UE may select the N power amplifier backoff values with the top CSI values based at least in part on the respective relative power consumption value (relativeP) for each power amplifier backoff value and a performance metric, such as spectral efficiency (specEff), that is based on the respective CSI value (e.g., SNR, CQI, or MCS) derived for each power amplifier backoff value. For example, the UE may report the CSI values for the N power amplifier backoff values with the highest ratio of specEff/relativeP. In some aspects, the selection criterion may indicate that N>1 or that N=1. In a case in which N=1, the UE may include a single CSI value for a best Tx configuration parameter (e.g., a best power amplifier backoff value). In this case, the UE (e.g., the Rx node) may report a single recommended Tx configuration parameter value (e.g., power amplifier backoff value) to be used by the network node (e.g., the Tx node) for transmitting the downlink communication.

In some aspects, the CSI values indicated in the report may include CQI values, MCS values, SINR values, SNR values, or data rate values (e.g., achievable data rates), among other examples. In some examples, the CSI values for one or more power amplifier backoff values may include CQI values or MCS values. In some other examples, the CSI values for one or more Tx power values may include achievable data rate values.

In some aspects, the reported CSI values for different Tx configuration parameter values may be reported as absolute values or relative values. For example, the reported CSI values for one or more Tx configuration parameter values other than the reference Tx configuration parameter value may be indicated in the report as relative values with respect to a baseline CSI value for the reference signal (e.g., a baseline CSI value associated with the reference Tx configuration parameter value). In some examples, the relative value for a reported CSI value may be an offset between the CSI value and the baseline CSI value (e.g., CSI(BO)=baselineCSI(reference BO)+relativeCSI(BO), where relativeCSI(BO) is reported for a power amplifier backoff value BO). In some aspects, the relative value may have a finer granularity than the absolute value.

In some aspects, the UE (e.g., the Rx node) may include the baseline CSI value associated with the reference Tx configuration parameter value and the CSI values associated with one or more Tx configuration parameter values, other than the reference Tx configuration parameter value, in the same report. In some other aspects, the UE (e.g., the Rx node) may include the baseline CSI value associated with the reference Tx configuration parameter value and the CSI values associated with the Tx configuration parameter values other than the reference Tx configuration parameter value in separate reports. For example, the UE may transmit (and the network node may receive) a first report that includes the baseline CSI value associated with the reference Tx configuration parameter value. The UE may transmit (and the network node may receive) a second report that includes relative CSI values, with respect to the baseline CSI value, for one or more Tx configuration parameter values that are different from the reference Tx configuration parameter value. In some aspects, the UE may transmit the second report (e.g., including the relative CSI values, with respect to the baseline CSI value) less frequently than the first report (e.g., including the baseline CSI value). For example, in this case, the UE may transmit the second report, with the relative CSI values, to the network node once with the UE capability information (e.g., when establishing a connection with the network node), as compared with periodically transmitting the first report including the baseline CSI value.

In some aspects, the UE (e.g., the Rx node) may include, in the report, an indication of a mapping between different Tx configuration parameter values and the respective CSI values for the different Tx configuration parameter values. In some aspects, the report may include a mapping table that indicates the mapping between the different Tx configuration parameter values and the respective CSI values for the different Tx configuration parameter values. In some aspects, the report may include an indication of a linear function with a slope and an offset that characterize the mapping between the different Tx configuration parameter values and the respective CSI values. For example, in the case in which the Tx configuration parameter values are power amplifier backoff values, the report may include an indication of a mapping (a mapping table or a linear function that characterizes the mapping) from different power amplifier backoff values to CQI or MCS. In the case in which the Tx configuration parameter values are Tx power values, the report may include an indication of a mapping (a mapping table or a linear function that characterizes the mapping) from different Tx power values to CQI or rate.

As further shown in FIG. 7, and by reference number 735, the network node (e.g., the Tx node) may select a Tx configuration parameter value, from the plurality of Tx configuration parameter values, based at least in part on the respective CSI values for the Tx configuration parameter values. For example, the network node may select a Tx configuration parameter based at least in part on the CSI values, for one or more of the Tx configuration parameter values, indicated in the report received from the UE.

In some aspects, the network node may select a Tx configuration parameter value, from the plurality of Tx configuration parameter values, based on the reported CSI values for the Tx configuration parameter values and a performance metric. For example, the performance metric may compare the performance (e.g., spectral efficiency) and energy consumption for each Tx configuration parameter value (or for each Tx configuration parameter value for which the respective CSI is reported) to select a Tx configuration parameter value that optimizes energy efficiency. In some aspects, in the case in which the Tx configuration parameter values are different power amplifier backoff values, the network node may determine a spectral efficiency for each power amplifier backoff value with a reported CSI value based at least in part on the reported CSI value (e.g., CQI value, MCS value, or SNR value). The network node may determine a relative power consumption value (relativeP) for each power amplifier backoff value based on the relative power efficiency with respect to the reference power amplifier backoff value, using the power consumption evaluation model for power amplifier backoff discussed above. The network node may then select the power amplifier backoff value with the highest value for the ratio of specEff/relativeP.

As further shown in FIG. 7, and by reference number 740, the network node (e.g., the Tx node) may transmit a downlink transmission to the UE (e.g., the Rx node) using the selected Tx configuration parameter value. For example, the network node may transmit the downlink transmission using the Tx configuration parameter value (e.g., the power amplifier backoff value, the Tx power value, the DAC resolution, or the CFR parameter) selected from the plurality of Tx configuration parameter values based at least in part on CSI values for the Tx configuration parameter values that are derived based on the reference signal associated with the reference Tx configuration parameter value. The UE (e.g., the Rx node) may receive the downlink transmission associated with (e.g., transmitted by the Tx node with) the selected Tx configuration parameter value.

As indicated above, FIG. 7 is provided as an example. Other examples may differ from what is described with respect to FIG. 7.

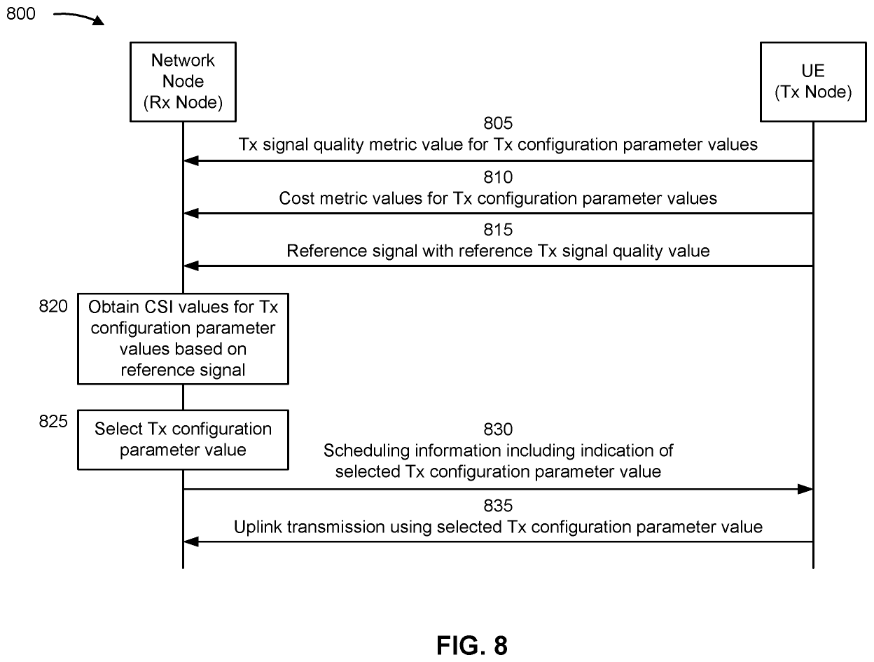

FIG. 8 is a diagram illustrating an example 800 associated with CSI enhancement for Tx configuration parameter selection, in accordance with the present disclosure. As shown in FIG. 8, example 800 includes communication between a network node (e.g., BS 110 or a disaggregated base station as discussed with respect to FIG. 3) and a UE (e.g., UE 120). In some aspects, the network node and the UE may be included in a wireless network, such as wireless network 100. The network node and the UE may communicate via a wireless access link, which may include an uplink and a downlink.

As shown in FIG. 8, example 800 is associated with CSI enhancement for Tx configuration parameter selection or adaptation for downlink communication. In example 800, the UE is a Tx node for transmitting an uplink communication, and the network node is an Rx node for receiving the uplink communication. In this case, the Rx node (e.g., the network node) is the scheduling node for the uplink communication, and the Tx node (e.g., the UE) is the scheduled node for the uplink communication. In some aspects, the enhanced CSI framework discussed in connection with FIG. 8 may be used for power amplifier backoff adaptation to select a power amplifier backoff to be used by network node for downlink transmission. In some other aspects, the CSI enhance framework discussed in connection with FIG. 8 may be used for selection or adaptation of another Tx configuration parameter for downlink transmission, such as a Tx power value, a DAC resolution, or a CFR parameter, among other examples.

As shown in FIG. 8, and by reference number 805, the UE (e.g., the Tx node) may transmit, and the network node (e.g., the Rx node) may receive an indication of respective Tx signal quality metric values for a plurality of Tx configuration parameter values. The plurality of Tx configuration parameter values may include different possible values for a Tx configuration parameter to be used by the UE to transmit an uplink communication. In some aspects, each Tx configuration parameter value may be associated with a different Tx distortion. For example, the Tx configuration parameter values may include different possible power amplifier backoff values, Tx power values (or Tx power offset values), DAC resolutions, or CFR parameter values. In some aspects, the Tx configuration parameter values may include a reference Tx configuration parameter value to be used to transmit a reference signal and one or more other Tx configuration parameter values, different from the reference Tx configuration parameter value, that are possible values to be used to transmit an uplink communication.

In some aspects, the UE may transmit, and the network node may receive, an indication of the reference Tx configuration parameter value for the reference signal and other Tx configuration parameter values for which CSI values are to be derived based on the reference signal transmitted with the reference Tx configuration parameter value. In one example (e.g., for power amplifier backoff adaptation), the UE may indicate a reference power amplifier backoff value to be used for transmitting the reference signal and one or more other power amplifier backoff values for which CSI values are to be derived by the network node. In another example (e.g., for Tx power selection in a variable Tx power scheme), the UE may indicate a reference Tx power value to be used for transmitting the reference signal and other Tx power values for which CSI values are to be derived. In some aspects, the UE may transmit the indication of the Tx configuration parameter values together with, or independent from, the Tx signal quality metric values for the Tx configuration parameter values.

In some aspects, the respective Tx signal quality metric values, for the Tx configuration parameter values, may be values of a Tx signal quality metric. For example, the Tx signal quality metric may be EVM, Tx SNR, or a maximum achievable rate limit. The Tx signal quality metric value, for each Tx configuration parameter value, may be a value for the Tx signal quality metric corresponding to the Tx configuration parameter that is known (e.g., stored) or obtained (e.g., determined, derived, calculated, identified, received, or acquired) by the Tx node (e.g., the UE). For example, different power amplifier backoff values may be mapped to respective EVM values that correspond to the upper limits to received SNR for the different power amplifier backoff values. The Tx signal quality metric values may include a reference Tx signal quality metric value for a reference Tx configuration parameter value (e.g., for the reference signal) and respective Tx signal quality metric values for the Tx configuration parameter values other than the reference Tx configuration parameter value. In some aspects, indication of the Tx signal quality metric values may include an indication of the reference Tx signal quality metric value and the respective Tx signal quality metric values for the Tx configuration parameter values other than the reference Tx configuration parameter value. In one example, in a case in which the Tx configuration parameter values are power amplifier backoff values, the Tx signal quality metric values may include a reference EVM (EVM_{ref}) for the reference power amplifier backoff to be used to transmit the reference signal and EVM values (EVM₁, . . . , EVM_{N}) for the power amplifier backoff values other than the reference power amplifier backoff value.

As further shown in FIG. 8, and by reference number 810, the UE (e.g., the Tx node) may transmit, and the network node (e.g., the Rx node) may receive, cost metric values for the Tx configuration parameter values. For example, the UE may transmit, and the network node may receive, respective cost metric values for the plurality of Tx configuration parameter values. In some aspects, the respective cost metric value for each Tx configuration parameter value may be indicative of a Tx energy consumption for the Tx configuration parameter value. In some examples, the cost metric values may be absolute values for a Tx energy consumption metric or relative values with respect to the reference signal. For example, for a power amplifier backoff value, a relative cost metric value may be a ratio of a power amplifier efficiency for the power amplifier backoff value to a power amplifier efficiency of the reference power amplifier backoff value used for transmitting the reference signal. In this case, the cost metric for each power amplifier backoff value may be a relative power amplifier efficiency value, expressed as:

$$relativePAEff ( {BO}_{i} ) = \frac{PAEff ( {BO}_{i} )}{PAEff ( {BO}_{ref} )}$$

where BOᵢ denotes a power amplifier backoff value, BO_{ref} denotes the reference power amplifier backoff value, and PAEff denotes the power amplifier efficiency.

As further shown in FIG. 8, and by reference number 815, the UE (e.g., the Tx node) may transmit, and the network node (e.g., the Rx node) may receive, a reference signal associated with the reference signal quality metric value (e.g., a reference signal associated with the reference Tx configuration parameter value). That is, the UE may transmit the reference signal using the reference Tx configuration parameter value (e.g., the Tx configuration parameter value associated with the reference Tx signal quality metric value). For example, the reference signal may be an SRS, or another uplink reference signal. In one example, in a case in which the Tx configuration parameter values are different power amplifier backoff values, the UE may transmit the reference signal using the reference power amplifier backoff value. In another example, in a case in which the Tx configuration parameter values are different Tx powers, the UE may transmit the reference signal using the reference Tx power.

As further shown in FIG. 8, and by reference number 820, the network node (e.g., the Rx node) may obtain CSI values for the Tx configuration parameter values that are based at least in part on the reference signal associated with (e.g., transmitted using) the reference Tx configuration parameter. As used herein, “obtaining” the CSI values may include deriving, determining, calculating, identifying, receiving, or acquiring the CSI values, or any combination thereof. In some aspects, the network node may derive a set of CSI values, that includes respective CSI values for the plurality of Tx configuration parameter values, based at least in part on a measurement (e.g., an SNR measurement) of the reference signal transmitted using the reference Tx configuration parameter value. For example, the respective CSI values, for the plurality of Tx configuration parameter values, may include respective CQI values, MCS values, SINR values, SNR values, or data rate values, among other examples. In some aspects, the network node may derive the respective CSI values for the plurality of Tx configuration parameter values based at least in part on the respective Tx signal quality metric values for the plurality Tx configuration parameter values, the reference Tx signal quality metric value, and the measurement (e.g., SNR measurement) of the reference signal.

In some aspects (e.g., in a case in which the Tx configuration parameter values are power amplifier backoff values), the Tx signal quality metric values may be EVM values. That is, the reference Tx signal quality metric value may be a reference EVM value (EVM_{ref}), and the respective Tx signal quality metric values for the plurality of Tx configuration parameter values (e.g., power amplifier backoff values) may be respective EVM values (EVM₁, . . . , EVM_{N}). In this case, the network node may derive respective SNR values for the plurality of Tx configuration parameter values (e.g., power amplifier backoff values) based at least in part on the respective EVM values (EVM₁, . . . , EVM_{N}), the reference EVM value (EVM_{ref}), and a measured SNR value (SNR_{ref}) of the reference signal. For example, the network node may determine the respective SNR value (SNR_{data}) for each Tx configuration parameter value (e.g., for each power amplifier backoff value) as

$${SNR}_{data} = \frac{1}{{EVM}_{data}^{2} - {EVM}_{ref}^{2} + \frac{1}{{SNR}_{ref}}} .$$

In some aspects, the respective CSI values for the Tx configuration parameter values may include the respective SNR values derived for the Tx configuration parameter values. In some aspects, the network node may determine another respective CSI value (or CSI values) for each Tx configuration parameter value (e.g., each power amplifier backoff value) based at least in part on the respective SNR value (SNR_{data}) for each Tx configuration parameter value.

In some aspects, in the case in which the Tx configuration parameter values are power amplifier backoff values, the network node may determine a respective CQI value or a respective modulation and MCS value for each power amplifier backoff value based at least in part on the respective SNR value (SNR_{data}) derived for each power amplifier backoff value. In this case, the network node may determine a respective spectral efficiency based on the derived SNR value (SNR_{data}) for each power amplifier backoff value, for example, based at least in part on a mapping between SNR and spectral efficiency. The network node may determine a respective CQI value based on the spectral efficiency for each power amplifier backoff, for example, using a mapping between CQI and spectral efficiency, and/or the network node may determine a respective MCS value based on the spectral efficiency for each power amplifier backoff, for example, using a mapping between MCS and spectral efficiency. In some aspects, the network node may derive SNR values and/or determine CQI, MCS, or other CSI values based on derived SNR values, for other types of Tx configuration parameter value similarly to as described for power amplifier backoff values.

In some aspects, in a case in which the Tx configuration parameter values are different Tx power values, the network node may derive achievable data rates for the different power values based at least in part on a measurement of the reference signal transmitted using a reference Tx power. In this case, an SNR value for a Tx power value (P_{data}) may be derived as a scaled value of the measured SNR value for the reference signal transmitted at the reference Tx power (P_{ref}). For example, for each Tx power value (P_{data}), the network node may derive the respective SNR value as

$$SNR ( {P}_{data} ) = \frac{{P}_{data}}{{P}_{ref}} \cdot SNR ( {P}_{ref} ) .$$

The network node may then determine a respective achievable data rate, rate(SNR(P_{data})), for each Tx power value (P_{data}), based on a mapping of SNR to rate. In this case, a set of CSI values reported for the different Tx power value may include the respective achievable data rates derived for one or more of the different Tx power values.

As further shown in FIG. 8, and by reference number 825, the network node (e.g., the Rx node) may select a Tx configuration parameter value, from the plurality of Tx configuration parameter values, based at least in part on the respective CSI values for the Tx configuration parameter values. For example, the network node may select a Tx configuration parameter based at least in part on the respective CSI values, for the plurality of Tx configuration parameter values, derived by the network node.

In some aspects, the network node may select a Tx configuration parameter value, from the plurality of Tx configuration parameter values, based on the respective CSI values for the plurality of Tx configuration parameter values, the respective cost metrics for the plurality of Tx configuration parameters, and a performance metric. For example, the performance metric may compare the performance (e.g., spectral efficiency) and an energy consumption value determined based at least in part on the respective cost metric value for each Tx configuration parameter value to select a Tx configuration parameter value that optimizes energy efficiency. In some aspects, in the case in which the Tx configuration parameter values are different power amplifier backoff values, the respective cost metric value for each power amplifier backoff value may be a respective power amplifier efficiency value or a respective relative power amplifier efficiency with respect to the reference signal

$$( e . g . , relativePAEff ( {BO}_{i} ) = \frac{PAEff ( {BO}_{i} )}{PAEff ( {BO}_{ref} )} ) .$$

In this case, the network node may determine a respective relative power consumption value (relativeP) for each power amplifier backoff value using the power consumption evaluation model for power amplifier backoff discussed above. The network node may determine a spectral efficiency (specEff) for each power amplifier backoff value based at least in part on the respective CSI value (e.g., CQI value, MCS value, or SNR value) for the power amplifier backoff value. The network node may then select the power amplifier backoff value with the highest value for the ratio of specEff/relativeP.

As further shown in FIG. 8, and by reference number 830, the network node (e.g., the Rx node and the scheduling node) may transmit, and the UE (e.g., the Tx node and the scheduled node) may receive, scheduling information that schedules an uplink transmission from the UE (e.g., the Tx node). The scheduling information may indicate the selected Tx configuration parameter value. For example, the scheduling information may indicate that the selected Tx configuration parameter value is to be used by the UE for transmitting the uplink transmission scheduled by the scheduling information. In some aspects, the scheduling information, including the indication of the selected Tx configuration parameter value, may be included in an uplink grant. For example, the scheduling information, including the indication of the selected Tx configuration parameter value, may be included in DCI that allocates resources to the UE for an uplink transmission. In some aspects, the scheduling information may indicate a selected power amplifier backoff value, a selected Tx power value, or another selected Tx configuration parameter value, to be used by the UE to transmit the uplink transmission.

As further shown in FIG. 8, and by reference number 835, the UE (e.g., the Tx node) may transmit an uplink transmission to the network node (e.g., the Rx node) using the selected Tx configuration parameter value indicated in the scheduling information. For example, the UE may transmit the uplink transmission using the Tx configuration parameter value (e.g., the power amplifier backoff value, the Tx power value, the DAC resolution, or the CFR parameter) selected, by the network node, from the plurality of Tx configuration parameter values based at least in part on CSI values for the Tx configuration parameter values that are derived based on the reference signal associated with the reference Tx configuration parameter value. The network node (e.g., the Rx node) may receive the uplink transmission associated with (e.g., transmitted by the Tx node with) the selected Tx configuration parameter value.

As indicated above, FIG. 8 is provided as an example. Other examples may differ from what is described with respect to FIG. 8.

FIGS. 9A-9C are diagrams illustrating an example 900 associated with CSI enhancement for power amplifier backoff adaptation, in accordance with the present disclosure. Example 900 is an example of deriving CSI values for power amplifier backoff adaptation with power amplifier backoff values of 3.9 dB, 8 dB, and 10.5 dB. For example, the results shown in FIGS. 9A-9C are associated with different power amplifier backoff values (e.g., 3.9 dB, 8 dB, and 10.5 dB) for a fixed power amplifier output power (e.g., 10 dB) based on the example power amplifier data shown in FIG. 5C. In example 900, the highest power amplifier backoff value (BO=10.5) is used as the reference power amplifier backoff value. In example 900, −EVMdB_{ref}=28 dB (BO=10.5), and −EVMdB_{data}≤−EVMdB_{ref}, where EVMdB_{ref} is the reference EVM value for reference power amplifier backoff and EVMdB_{data} is a EVM value for a power amplifier backoff value in the set of possible power amplifier backoff values.

The first column of table 905 of FIG. 9A shows measured SNR values (SNR_{ref}(dB)) of the reference signal transmitted with the reference power amplifier backoff value of 10.5 dB. The second column of table 905 shows the −EVMdB_{data} values and power amplifier efficiency (PAEff) for each power amplifier backoff value (BO). For example, for BO=3.9, −EVMdB_{data}=14.9 and PAEff=14%; for BO=8, −EVMdB_{data}=23.1 and PAEff=10%; and for BO=10.5, −EVMdB_{data}=28 (e.g., the same as −EVMdB_{ref}) and PAEff=8%. As described above in connection with FIGS. 7 and 8, the Rx node may derive SNR values for different power amplifier backoff values based on measured SNR of the reference signal. The third column of table 905 shows derived SNR values (SNR_{data}(dB)) for each power amplifier backoff value based on the measured SNR_{ref}(dB) value in the first column. For example, with a measured reference signal SNR value of SNR_{ref}(dB)=27 dB, SNR_{data}(dB)=14.84 for BO=3.9, SNR_{data}(dB)=22.75 for BO=8, and SNR_{data}(dB)=27 for BO=10.5 (e.g., the reference power amplifier backoff value). The fourth column of table 905 shows spectral efficiency (specEff) values determined based on the SNR_{data}(dB) values in the third column. The Rx node may determine the spectral efficiency values for each derived SNR value based on a mapping between SNR and spectral efficiency. For example, graph 910 shows an example mapping between SNR and spectral efficiency (e.g., between SNR and mutual information (MI), which is used to characterize spectral efficiency) for different MCSs. As discussed above in connection with FIGS. 7 and 8, a ratio of specEff/relativeP may be used to evaluate the different power amplifier backoff values and select a best power amplifier backoff for a transmission. The fifth column of Table 905 shows values of specEff/relativeP based on the derived SNR values for the power amplifier relativeP backoff values for each measured SNR_{ref}(dB) value. For each measured SNR_{ref}(dB) value, the selected power amplifier backoff value (shown with a star in FIG. 9A) may be the power amplifier backoff value with the highest value for specEff/relativeP. As shown in FIG. 9A, the power amplifier backoff value of BO=8 may be selected for SNR_{ref}(dB)=27 and SNR_{ref}(dB)=20, and the power amplifier backoff of BO=3.9 may be selected for SNR_{ref}(dB)=14 and SNR_{ref}(dB)=10. In this example, power amplifier backoff adaptation using the selected power amplifier backoff values may result in up to a 20% gain in energy efficiency, as compared to a non-adaptive scheme with a fixed power amplifier backoff value of BO=10.5.

As shown in FIG. 9B, the first column of table 915 shows the measured SNR_{ref}(dB) values for the reference signal transmitted with the reference power amplifier backoff value (BO=10.5). The second column of table 915 shows the estimated specEff values determined for the power amplifier backoff values for each SNR_{ref}(dB) value. The third column of table 915 shows a baseline CQI value (and corresponding modulation (e.g., quadrature amplitude modulation (QAM) and spectral efficiency)) for the reference power amplifier backoff value (BO=10.5) determined based on the estimated specEff value for the reference power amplifier backoff, for each measured SNR_{ref}(dB) value. For example, the table 920 shows an example mapping between CQI and spectral efficiency. CQI maps to a quantized version of spectral efficiency, so the specEff value corresponding to the baseline CQI value may not be exactly the same as the estimated specEff determined from the SNR value. The fourth column of table 915 shows respective CQI indications for the power amplifier backoff values to be included in an enhanced report, for each measured SNR_{ref}(dB) value. The CQI values for the power amplifier backoff values other than the reference power amplifier backoff value may be determined based on the estimated specEff values for the power amplifier backoff values using a mapping between CQI and spectral efficiency (e.g., table 920). As shown in table 915, in some aspects, the UE/Rx node may report the baseline CQI value (e.g., CQI=15 for SNR_{ref}(dB)=27) for the reference power amplifier backoff value (BO=10.5) and differential CQI correction values (e.g., CQI-1 and CQI-5) for the other power amplifier backoff values (e.g., BO=8 and BO=3.9). In this case, the differential CQI correction value indicates an offset between the baseline CQI value and the CQI value determined for a power amplifier backoff value. For example, when the baseline CQI=15, the differential correction value of CQI-1 indicates a CQI value of 14. In some other aspects, the UE/Rx node may report a selected CQI value and the associated power amplifier backoff value.

As shown in FIG. 9C, the first column of table 925 shows the measured SNR_{ref}(dB) values for the reference signal transmitted with the reference power amplifier backoff value (BO=10.5). The second column of table 925 shows the estimated specEff values determined for the power amplifier backoff values for each SNR_{ref}(dB) value. The third column of table 925 shows the baseline CQI value for the reference power amplifier backoff value (BO=10.5), for each measured SNR_{ref}(dB) value. The baseline CQI value and corresponding spectral efficiency may map to a baseline MCS value for the reference power amplifier backoff value. For example, table 930 shows an example mapping between MCS and spectral efficiency. As shown in the fourth column of table 925, in some aspects, the UE/Rx node may report the baseline CQI value (e.g., CQI=15 for SNR_{ref}(dB)=27) for the reference power amplifier backoff value (BO=10.5) and differential MCS correction values (e.g., CQI-1 and CQI-5), with respect to the baseline MCS value associated with the baseline CQI value, for the other power amplifier backoff values (e.g., BO=8 and BO=3.9). In this case, the differential MCS correction value indicates an offset between the baseline MCS value and the MCS value determined for a power amplifier backoff value. For example, when the baseline MCS=27 (e.g., the baseline CQI=15), the differential correction value of MCS-2 indicates an MCS value of 25. In some other aspects, the UE/Rx node may report a selected CQI value (or a selected MCS value) and the associated power amplifier backoff value.

As indicated above, FIGS. 9A-9C are provided as an example. Other examples may differ from what is described with respect to FIGS. 9A-9C.

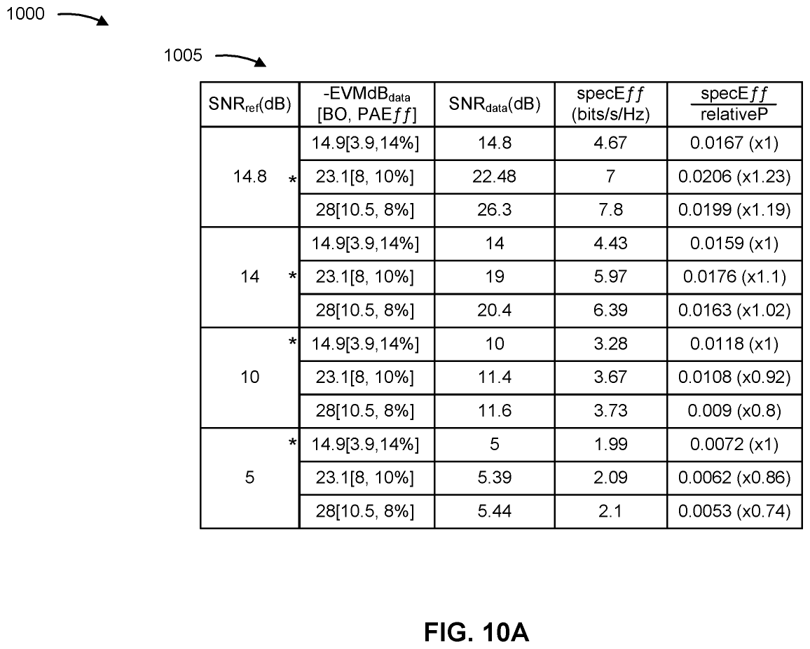

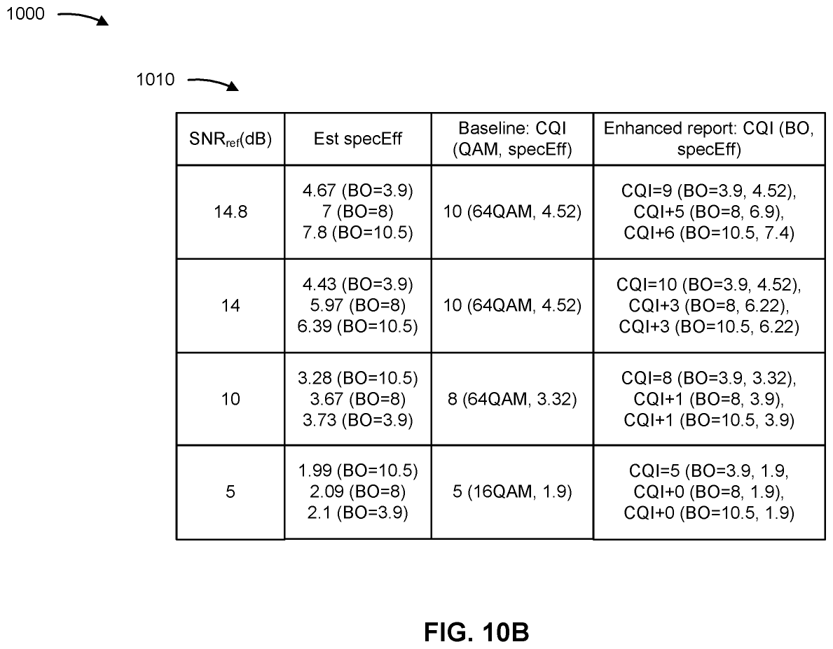

FIGS. 10A-10B are diagrams illustrating an example 1000 associated with CSI enhancement for power amplifier backoff adaptation, in accordance with the present disclosure. Example 1000 is an example of deriving CSI values for power amplifier backoff adaptation with power amplifier backoff values of 3.9 dB, 8 dB, and 10.5 dB. For example, the results shown in FIGS. 10A-10B are associated with different power amplifier backoff values (e.g., 3.9 dB, 8 dB, and 10.5 dB) for a fixed power amplifier output power (e.g., 10 dB) based on the example power amplifier data shown in FIG. 5C. In example 1000, the lowest power amplifier backoff value (BO=3.9) is used as the reference power amplifier backoff value. In example 1000, −EVMdB_{ref}=14.9 dB (BO−3.9), and −EVMdB_{data}≥−EVMdB_{ref}. In some aspects, a small power amplifier backoff with an advanced receiver may be used for the reference signal to save power consumption. However, the derived SNR_{data} values may be more sensitive to the measured SNR_{ref} with a reference signal transmitted using a smaller power amplifier backoff value.

The first column of table 1005 of FIG. 10A shows measured SNR_{ref}(dB) values of the reference signal transmitted with the reference power amplifier backoff value of 3.9 dB. The second column of table 1005 shows the −EVMdB_{data} values and power amplifier efficiency (PAEff) for each power amplifier backoff value. For example, for BO=3.9, −EVMdB_{data}=14.9 and PAEff=14%; for BO=8, −EVMdB_{data}=23.1 and PAEff=10%; and for BO=10.5, −EVMdB_{data}=28 (e.g., the same as −EVMdB_{ref}) and PAEff=8%. As described above in connection with FIGS. 7 and 8, the Rx node may derive SNR values for different power amplifier backoff values based on measured SNR of the reference signal. The third column of table 1005 shows derived SNR_{data}(dB) values for each power amplifier backoff value based on the measured SNR_{ref}(dB) value in the first column. For example, with a measured reference signal SNR value of SNR_{ref}(dB)=14.8 dB, SNR_{data}(dB)=14.8 for BO=3.9 (e.g., the reference power amplifier backoff value), SNR_{data}(dB)=22.48 for BO=8, and SNR_{data}(dB)=26.3 for BO=10.5. The fourth column of table 1005 shows specEff values determined based on the SNR_{data}(dB) values in the third column. The Rx node may determine the spectral efficiency values for each derived SNR value based on a mapping between SNR and spectral efficiency (e.g., graph 910 of FIG. 9A). As discussed above in connection with FIGS. 7 and 8, a ratio of specEff/relativeP may be used to evaluate the different power amplifier backoff values and select a best power amplifier backoff for a transmission. The fifth column of Table 1005 shows values of specEff/relativeP based on the derived SNR values for the power amplifier backoff values for each measured SNR_{ref}(dB) value. For each measured SNR_{ref}(dB) value, the selected power amplifier backoff value (shown with a star in FIG. 10A) may be the power amplifier backoff value with the highest value for specEff/relativeP. As shown in FIG. 10A, the power relativeP amplifier backoff value of BO=8 may be selected for SNR_{ref}(dB)=14.8 and SNR_{ref}(dB)=14, and the power amplifier backoff of BO=3.9 may be selected for SNR_{ref}(dB)=10 and SNR_{ref}(dB)=5. In this example, power amplifier backoff adaptation using the selected power amplifier backoff values may result in up to a 20% gain in energy efficiency, as compared to a non-adaptive scheme with a fixed power amplifier backoff value of BO=3.9.

As shown in FIG. 10B, the first column of table 1010 shows the measured SNR_{ref}(dB) values for the reference signal transmitted with the reference power amplifier backoff value (BO=10.5). The second column of table 1010 shows the estimated specEff values determined for the power amplifier backoff values for each SNR_{ref}(dB) value. The third column of table 1010 shows a baseline CQI value (and corresponding modulation and spectral efficiency) for the reference power amplifier backoff value (BO=3.9) determined based on the estimated specEff value for the reference power amplifier backoff, for each measured SNR_{ref}(dB) value (e.g., using a mapping such as table 920 of FIG. 9B). The fourth column of table 1010 shows respective CQI indications for the power amplifier backoff values to be included in an enhanced report, for each measured SNR_{ref}(dB) value. The CQI values for the power amplifier backoff values other than the reference power amplifier backoff value may be determined based on the estimated specEff values for the power amplifier backoff values using a mapping between CQI and spectral efficiency (e.g., table 920 of FIG. 9B). As shown in table 1010, in some aspects, the UE/Rx node may report the baseline CQI value (e.g., CQI=9 for SNR_{ref}(dB)=14.8) for the reference power amplifier backoff value (BO=3.9) and differential CQI correction values (e.g., CQI+5 and CQI+6) for the other power amplifier backoff values (e.g., BO=8 and BO=10.5). In this case the differential CQI correction value indicates an offset between the baseline CQI value and the CQI value determined for a power amplifier backoff value. For example, when the baseline CQI=9, the differential correction value of CQI+5 indicates a CQI value of 14. In some other aspects, the UE/Rx node may report a selected CQI value and the associated power amplifier backoff value.

As indicated above, FIGS. 10A-10B are provided as an example. Other examples may differ from what is described with respect to FIGS. 10A-10B.

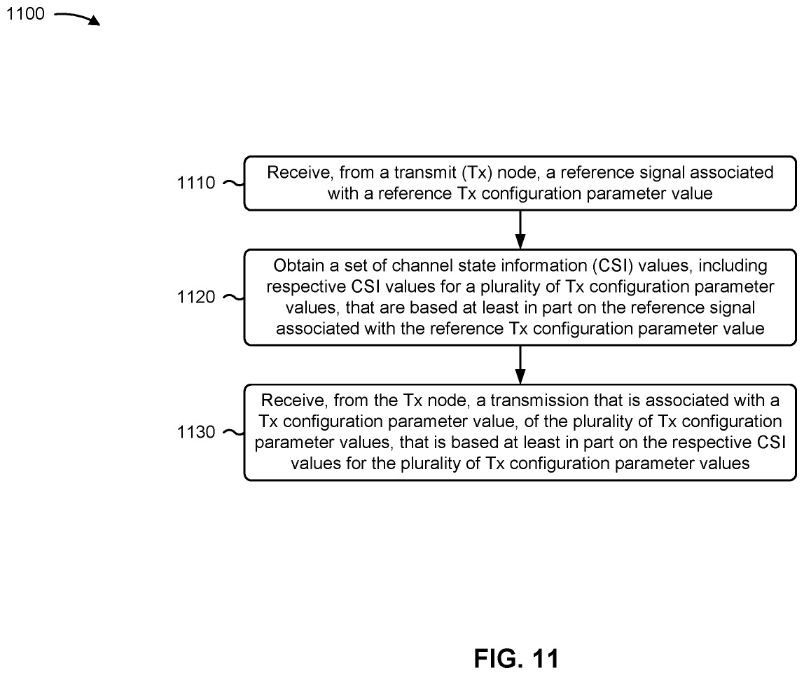

FIG. 11 shows a method 1100 for wireless communication by an Rx node, such as UE 120 or a network node (e.g., BS 110 or a disaggregated base station as discussed with respect to FIG. 3).

Method 1100 begins at step 1110 with receiving, from a Tx node, a reference signal associated with a reference Tx configuration parameter value.

Method 1100 then proceeds to step 1120 with obtaining a set of CSI values, including respective CSI values for a plurality of Tx configuration parameter values, that are based at least in part on the reference signal associated with the reference Tx configuration parameter value.

Method 1100 then proceeds to step 1130 with receiving, from the Tx node, a transmission that is associated with a Tx configuration parameter value, of the plurality of Tx configuration parameter values, that is based at least in part on the respective CSI values for the plurality of Tx configuration parameter values.

In a one aspect, method 1100 further includes receiving, from the Tx node, an indication of the reference Tx configuration parameter value and the plurality of Tx configuration parameter values.

In a one aspect, the plurality of Tx configuration parameter values include a plurality of values for a first Tx configuration parameter, the reference Tx configuration parameter value is a reference value for the first Tx configuration parameter, and the first Tx configuration parameter is a power amplifier backoff value, a Tx power offset, a digital-to-analog converter resolution, or a crest factor reduction parameter.

In a one aspect, method 1100 further includes receiving, from the Tx node, an indication of a reference Tx signal quality metric value for the reference signal and respective Tx signal quality metric values for the plurality of Tx configuration parameter values.

In a one aspect, the respective Tx signal quality metric values for the plurality of Tx configuration parameter values include respective values for a first Tx signal quality metric, the reference Tx signal quality metric value is a value for the first Tx signal quality metric for the reference signal, and the first Tx signal quality metric is an EVM, a Tx SNR, or a maximum achievable rate limit.

In a one aspect, obtaining the set of CSI values includes deriving the respective CSI values for the plurality of Tx configuration parameter values based at least in part on the respective Tx signal quality metric values for the plurality of Tx configuration parameter values, the reference Tx signal quality metric value, and a measurement of the reference signal.

In a one aspect, the reference Tx signal quality metric value is a reference EVM value and the respective Tx signal quality metric values include respective EVM values for the plurality of Tx configuration parameter values, and deriving the respective CSI values further includes deriving respective SNR values for the plurality of Tx configuration parameter values based at least in part on the respective EVM values for the plurality of Tx configuration parameter values, the reference EVM value, and a measured SNR value for the reference signal.

In a one aspect, method 1100 further includes transmitting, to the Tx node, a report including one or more of the respective CSI values for the plurality of Tx configuration parameter values.

In a one aspect, method 1100 further includes transmitting, to the Tx node, an indication of a UE capability for deriving the set of CSI values.

In a one aspect, the indication of the UE capability for deriving the set of CSI values includes an indication of a preferred reference Tx signal quality metric value for the reference signal.

In a one aspect, method 1100 further includes receiving a reporting configuration for reporting the one or more of the respective CSI values for the plurality of Tx configuration parameter values, wherein transmitting the report includes transmitting the report in accordance with the reporting configuration.

In a one aspect, the reporting configuration indicates one or more triggering conditions for reporting the one or more of the respective CSI values for the plurality of Tx configuration parameter values, and transmitting the report in accordance with the reporting configuration includes transmitting the report in connection with a triggering condition, of the one or more triggering conditions, being satisfied.

In a one aspect, the one or more triggering conditions include a triggering condition that is satisfied in connection with a difference between a respective CSI value for at least one Tx configuration parameter value of the plurality of Tx configuration parameter values and a baseline CSI value for the reference signal satisfying a threshold.

In a one aspect, the reporting configuration indicates a selection criterion for selecting the one or more of the respective CSI values for the plurality of Tx configuration parameter values to be included in the report.

In a one aspect, the selection criterion indicates one or more selected Tx configuration parameter values of the plurality of Tx configuration parameter values, and the one or more of the respective CSI values included in the report include the respective CSI values for the one or more selected Tx configuration parameter values.

In a one aspect, the selection criterion indicates that CSI values, of the respective CSI values for the plurality of Tx configuration parameter values, that are within a range of a baseline CSI value for the reference signal are to be included in the report.

In a one aspect, the selection criterion indicates that CSI values, of the respective CSI values for the plurality of Tx configuration parameter values, that are outside of a range of a baseline CSI value for the reference signal are to be included in the report.

In a one aspect, the selection criterion indicates a quantity of CSI values to be included in the report.

In a one aspect, method 1100 further includes receiving an indication of respective cost metric values for the plurality of Tx configuration parameter values, wherein the one or more of the respective CSI values included in the report include the quantity of CSI values selected from the respective CSI values for the plurality of Tx configuration parameter values based at least in part on the respective cost metric values for the plurality of Tx configuration parameter values.

In a one aspect, the report indicates, for each CSI value of the one or more of the respective CSI values included in the report, a relative value for the CSI value with respect to a baseline CSI value for the reference signal.

In a one aspect, the relative value, for each CSI value of the one or more of the respective CSI values included in the report, is an offset between the CSI value and the baseline CSI value.

In a one aspect, the respective CSI values for the plurality of Tx configuration parameter values may include respective CQI values for the plurality of Tx configuration parameter values, respective MCS values for the plurality of Tx configuration parameter values, or respective SINR values for the plurality of Tx configuration parameter values.

In a one aspect, the report includes the one or more of the respective CSI values for the plurality of Tx configuration parameter values and a baseline CSI value for the reference signal.

In a one aspect, transmitting the report includes transmitting a first report including a baseline CSI value for the reference signal, and transmitting a second report including respective relative CSI values, with respect to the baseline CSI value, for one or more of the plurality of Tx configuration parameter values that are different from the reference Tx configuration parameter value.

In a one aspect, the report includes an indication of a mapping between different Tx configuration parameter values, of the plurality of Tx configuration parameter values, and the respective CSI values for the different Tx configuration parameter values.

In a one aspect, the indication of the mapping includes an indication of a linear function with a slope and an offset that characterize the mapping.

In a one aspect, method 1100 further includes selecting the Tx configuration parameter value of the plurality of Tx configuration parameter values based at least in part on the respective CSI values for the plurality of Tx configuration parameter values.

In a one aspect, method 1100 further includes receiving, from the Tx node, an indication of respective cost metric values for the plurality of Tx configuration parameter values, wherein selecting the Tx configuration parameter value of the plurality of Tx configuration parameter values includes selecting the Tx configuration parameter value of the plurality of Tx configuration parameter values based at least in part on the respective CSI values for the plurality of Tx configuration parameter values, the respective cost metric values for the plurality of Tx configuration parameter values, and a performance metric.

In a one aspect, method 1100 further includes transmitting, to the Tx node, scheduling information scheduling the transmission from the Tx node and indicating that the Tx configuration parameter value of the plurality of Tx configuration parameter values is to be used for the transmission.

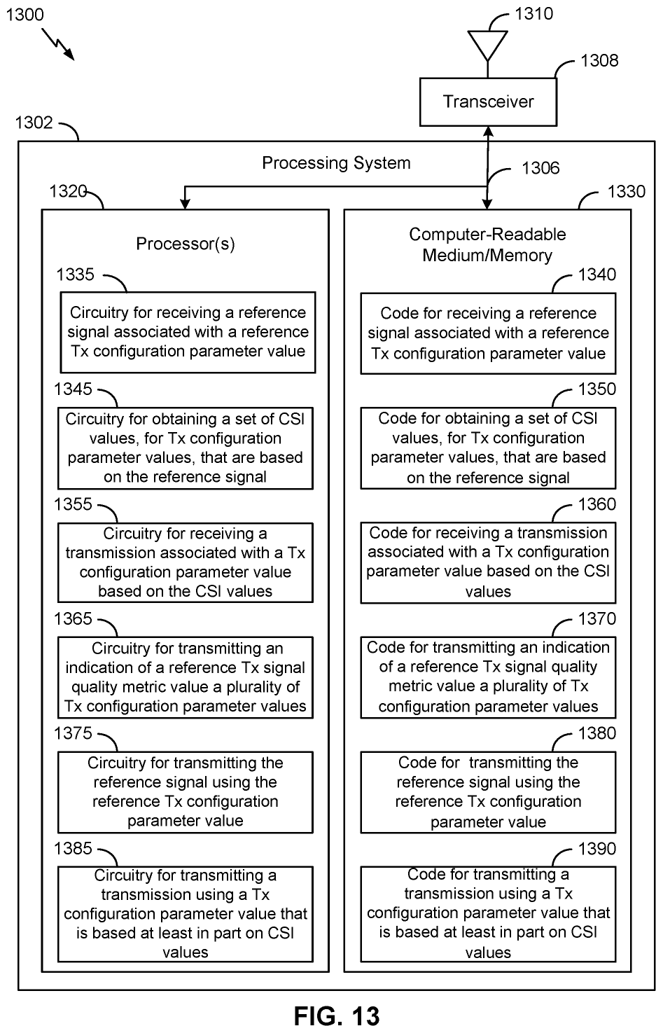

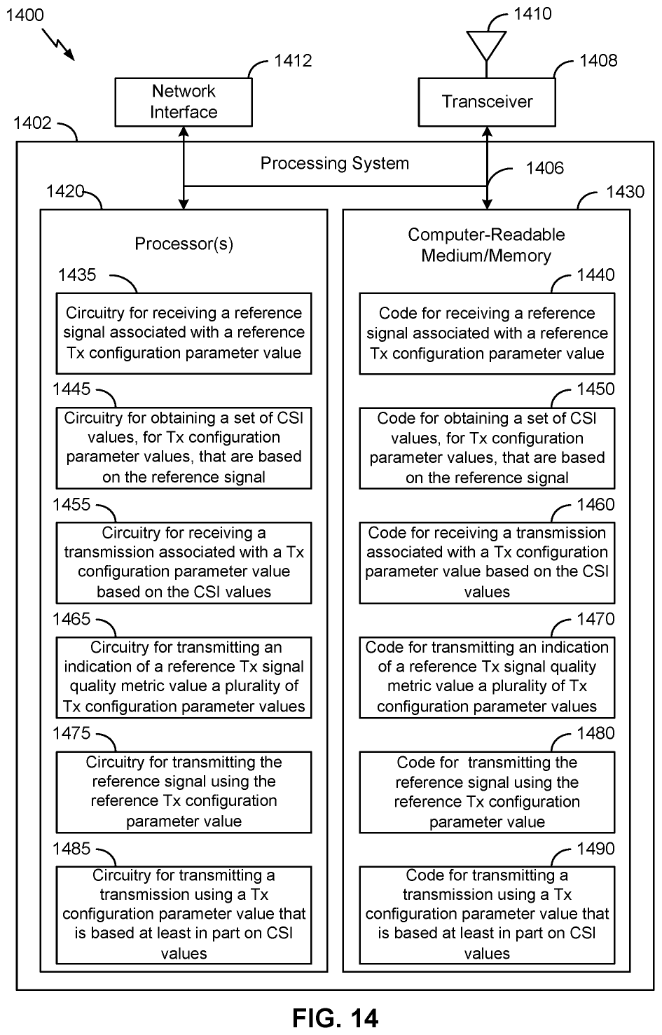

In one aspect, method 1100, or any aspect related to it, may be performed by an apparatus, such as communications device 1300 of FIG. 13 or communications device 1400 of FIG. 14, which includes various components operable, configured, or adapted to perform the method 1100. Communications device 1300 and Communications device 1400 are described below in further detail.

Note that FIG. 11 is just one example of a method, and other methods including fewer, additional, or alternative steps are possible consistent with this disclosure.

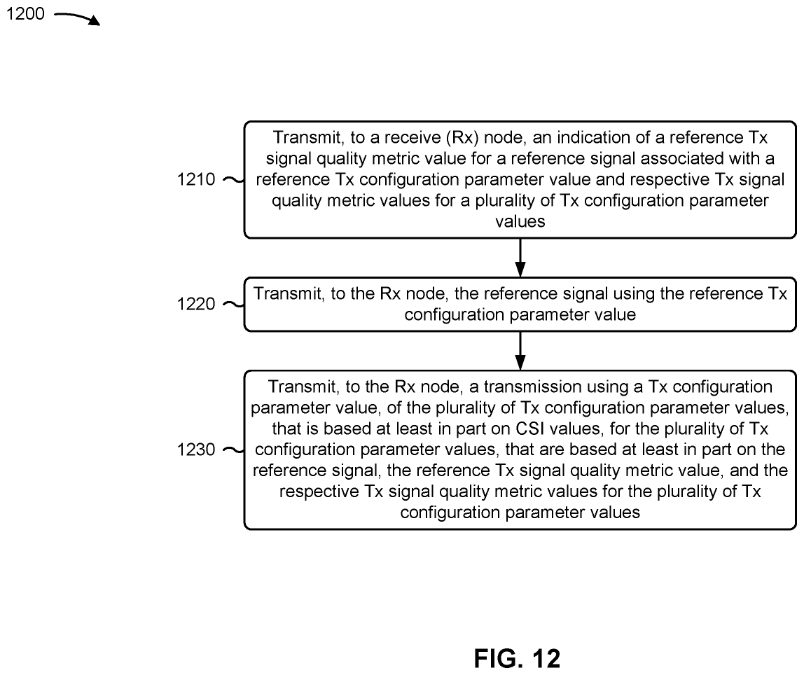

FIG. 12 shows a method 1200 for wireless communications by a Tx node, such as a network node (e.g., BS 110 or a disaggregated base station as discussed with respect to FIG. 3) or UE 120.

Method 1200 begins at step 1210 with transmitting, to an Rx node, an indication of a reference Tx signal quality metric value for a reference signal associated with a reference Tx configuration parameter value and respective Tx signal quality metric values for a plurality of Tx configuration parameter values.

Method 1200 then proceeds to step 1220 with transmitting, to the Rx node, the reference signal using the reference Tx configuration parameter value.

Method 1200 then proceeds to step 1230 with transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values.

In one aspect, method 1200 further includes transmitting an indication of the reference Tx configuration parameter value and the plurality of Tx configuration parameter values.

In one aspect, the plurality of Tx configuration parameter values include a plurality of values for a first Tx configuration parameter, the reference Tx configuration parameter value is a reference value for the first Tx configuration parameter, and the first Tx configuration parameter is a power amplifier backoff value, a Tx power offset, a digital-to-analog converter resolution, or a crest factor reduction parameter.

In one aspect, the respective Tx signal quality metric values for the plurality of Tx configuration parameter values include respective values for a first Tx signal quality metric, the reference Tx signal quality metric value is a value for the first Tx signal quality metric for the reference signal, and the first Tx signal quality metric is an EVM, a Tx SNR, or a maximum achievable rate limit.

In one aspect, method 1200 further includes receiving, from the Rx node, a report including respective CSI values for one or more of the plurality of Tx configuration parameter values.

In one aspect, method 1200 further includes receiving, from the Tx node, an indication of a UE capability for deriving the CSI values.

In one aspect, the indication of the UE capability for deriving the CSI values includes an indication of a preferred reference Tx signal quality metric value for the reference signal.

In one aspect, method 1200 further includes transmitting a reporting configuration for reporting the respective CSI values for the one or more of the plurality of Tx configuration parameter values.

In one aspect, the reporting configuration indicates one or more triggering conditions for reporting the one or more of the respective CSI values for the plurality of Tx configuration parameter values, and receiving the report includes receiving the report in connection with a triggering condition, of the one or more triggering conditions, being satisfied.

In one aspect, the one or more triggering conditions include a triggering condition that is satisfied in connection with a difference between a respective CSI value for at least one Tx configuration parameter value of the plurality of Tx configuration parameter values and a baseline CSI value for the reference signal satisfying a threshold.

In one aspect, the reporting configuration indicates a selection criterion for selecting the respective CSI values for the one or more of the plurality of Tx configuration parameter values to be included in the report.

In one aspect, the selection criterion indicates one or more selected Tx configuration parameter values of the plurality of Tx configuration parameter values, and the respective CSI values included in the report include respective CSI values for the one or more selected Tx configuration parameter values.

In one aspect, the selection criterion indicates that CSI values, of the CSI values for the plurality of Tx configuration parameter values, that are within a range of a baseline CSI value for the reference signal are to be included in the report.

In one aspect, the selection criterion indicates that CSI values, of the CSI values for the plurality of Tx configuration parameter values, that are outside of a range of a baseline CSI value for the reference signal are to be included in the report.

In one aspect, the selection criterion indicates a quantity of CSI values to be included in the report.

In one aspect, method 1200 further includes transmitting an indication of respective cost metric values for the plurality of Tx configuration parameter values, wherein the respective CSI values included in the report include respective CSI values for the quantity of Tx configuration parameter values selected based at least in part on the respective cost metric values for the plurality of Tx configuration parameter values.

In one aspect, the report indicates, for each CSI value of the respective CSI values included in the report, a relative value for the CSI value with respect to a baseline CSI value for the reference signal.

In one aspect, the relative value, for each CSI value of the respective CSI values included in the report, is an offset between the CSI value and the baseline CSI value.

In one aspect, the respective CSI values for the plurality of Tx configuration parameter values may include respective CQI values for the plurality of Tx configuration parameter values, respective MCS values for the plurality of Tx configuration parameter values, or respective SINR values for the plurality of Tx configuration parameter values.

In one aspect, the report includes the respective CSI values for the one or more of the plurality of Tx configuration parameter values and a baseline CSI value for the reference signal.

In one aspect, receiving the report includes receiving a first report including a baseline CSI value for the reference signal, and transmitting a second report including respective relative CSI values, with respect to the baseline CSI value, for one or more of the plurality of Tx configuration parameter values that are different from the reference Tx configuration parameter value.

In one aspect, the report includes an indication of a mapping between different Tx configuration parameter values, of the plurality of Tx configuration parameter values, and respective CSI values for the different Tx configuration parameter values.

In one aspect, the indication of the mapping includes an indication of a linear function with a slope and an offset that characterize the mapping.

In one aspect, method 1200 further includes selecting the Tx configuration parameter value, of the plurality of Tx configuration parameter values, based at least in part on the respective CSI values, for the one or more of the plurality of Tx configuration parameter values, included in the report.

In one aspect, method 1200 further includes transmitting an indication of respective cost metric values for the plurality of Tx configuration parameter values.

In one aspect, method 1200 further includes receiving, from the Rx node, scheduling information scheduling the transmission to the Tx node and indicating that the Tx configuration parameter value, of the plurality of Tx configuration parameter values, is to be used for the transmission.

In one aspect, method 1200, or any aspect related to it, may be performed by an apparatus, such as communications device 1300 of FIG. 13 or communications device 1400 of FIG. 14, which includes various components operable, configured, or adapted to perform the method 1200. Communications device 1300 and Communications device 1400 are described below in further detail.

Note that FIG. 12 is just one example of a method, and other methods including fewer, additional, or alternative steps are possible consistent with this disclosure.

FIG. 13 is a diagram illustrating an example of an implementation of code and circuitry for a communications device 1300, in accordance with the present disclosure. The communications device 1300 may be a UE, or a UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for receiving, from a Tx node, a reference signal associated with a reference Tx configuration parameter value (circuitry 1335).

As shown in FIG. 13, the communications device 1300 may include, stored in computer-readable medium/memory 1330, code for receiving, from a Tx node, a reference signal associated with a reference Tx configuration parameter value (code 1340).

As shown in FIG. 13, the communications device 1300 may include circuitry for obtaining a set of CSI values, including respective CSI values for a plurality of Tx configuration parameter values, that are based at least in part on the reference signal associated with the reference Tx configuration parameter value (circuitry 1345).

As shown in FIG. 13, the communications device 1300 may include, stored in computer-readable medium/memory 1330, code for obtaining a set of CSI values, including respective CSI values for a plurality of Tx configuration parameter values, that are based at least in part on the reference signal associated with the reference Tx configuration parameter value (code 1350).

As shown in FIG. 13, the communications device 1300 may include circuitry for receiving, from the Tx node, a transmission that is associated with a Tx configuration parameter value, of the plurality of Tx configuration parameter values, that is based at least in part on the respective CSI values for the plurality of Tx configuration parameter values (circuitry 1355).

As shown in FIG. 13, the communications device 1300 may include, stored in computer-readable medium/memory 1330, code for receiving, from the Tx node, a transmission that is associated with a Tx configuration parameter value, of the plurality of Tx configuration parameter values, that is based at least in part on the respective CSI values for the plurality of Tx configuration parameter values (code 1360).

Various components of the communications device 1300 may provide means for performing the method 1100 described with respect to FIG. 11, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

In certain aspects, the computer-readable medium/memory 1330 is configured to store instructions (e.g., computer-executable code, processor-executable code) that when executed by the one or more processors 1320, cause the one or more processors 1320 to perform the method 1200 described with respect to FIG. 12, or any aspect related to it. Note that reference to a processor performing a function of communications device 1300 may include one or more processors performing that function of communications device 1300.

As shown in FIG. 13, the communications device 1300 may include circuitry for transmitting, to an Rx node, an indication of a reference Tx signal quality metric value for a reference signal associated with a reference Tx configuration parameter value and respective Tx signal quality metric values for a plurality of Tx configuration parameter values (circuitry 1365).

As shown in FIG. 13, the communications device 1300 may include, stored in computer-readable medium/memory 1330, code for transmitting, to an Rx node, an indication of a reference Tx signal quality metric value for a reference signal associated with a reference Tx configuration parameter value and respective Tx signal quality metric values for a plurality of Tx configuration parameter values (code 1370).

As shown in FIG. 13, the communications device 1300 may include circuitry for transmitting, to the Rx node, the reference signal using the reference Tx configuration parameter value (circuitry 1375).

As shown in FIG. 13, the communications device 1300 may include, stored in computer-readable medium/memory 1330, code for transmitting, to the Rx node, the reference signal using the reference Tx configuration parameter value (code 1380).

As shown in FIG. 13, the communications device 1300 may include circuitry for transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values (circuitry 1385).

As shown in FIG. 13, the communications device 1300 may include, stored in computer-readable medium/memory 1330, code for transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values (code 1390).

Various components of the communications device 1300 may provide means for performing the method 1200 described with respect to FIG. 12, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

FIG. 14 is a diagram illustrating an example of an implementation of code and circuitry for a communications device 1400, in accordance with the present disclosure. The communications device 1400 may be a network node (such as BS 110 or a disaggregated base station as described with regard to FIG. 3), or a network node may include the communications device 1400.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of one or more of receive processor 238, transmit processor 220, TX MIMO processor 230, and/or controller/processor 240, as described with respect to FIG. 2. The one or more processors 1420 are coupled to a computer-readable medium/memory 1430 via a bus 1406. In various aspects, the computer-readable medium/memory 1430 may be representative of memory 242, as described with respect to FIG. 2. In certain aspects, the computer-readable medium/memory 1430 is configured to store instructions (e.g., computer-executable code, processor-executable code) that when executed by the one or more processors 1420, cause the one or more processors 1420 to perform the method 1100 described with respect to FIG. 11, or any aspect related to it. Note that reference to a processor performing a function of communications device 1400 may include one or more processors performing that function of communications device 1400.

As shown in FIG. 14, the communications device 1400 may include circuitry for receiving, from a Tx node, a reference signal associated with a reference Tx configuration parameter value (circuitry 1435).

As shown in FIG. 14, the communications device 1400 may include, stored in computer-readable medium/memory 1430, code for receiving, from a Tx node, a reference signal associated with a reference Tx configuration parameter value (code 1440).

As shown in FIG. 14, the communications device 1400 may include circuitry for obtaining a set of CSI values, including respective CSI values for a plurality of Tx configuration parameter values, that are based at least in part on the reference signal associated with the reference Tx configuration parameter value (circuitry 1445).

As shown in FIG. 14, the communications device 1400 may include, stored in computer-readable medium/memory 1430, code for obtaining a set of CSI values, including respective CSI values for a plurality of Tx configuration parameter values, that are based at least in part on the reference signal associated with the reference Tx configuration parameter value (code 1450).

As shown in FIG. 14, the communications device 1400 may include circuitry for receiving, from the Tx node, a transmission that is associated with a Tx configuration parameter value, of the plurality of Tx configuration parameter values, that is based at least in part on the respective CSI values for the plurality of Tx configuration parameter values (circuitry 1455).

As shown in FIG. 14, the communications device 1400 may include, stored in computer-readable medium/memory 1430, code for receiving, from the Tx node, a transmission that is associated with a Tx configuration parameter value, of the plurality of Tx configuration parameter values, that is based at least in part on the respective CSI values for the plurality of Tx configuration parameter values (code 1460).

Various components of the communications device 1400 may provide means for performing the method 1100 described with respect to FIG. 11, or any aspect related to it. For example, means for transmitting, sending, or outputting for transmission may include the transceiver(s) 232 and/or antenna(s) 234 of the BS 110 and/or transceiver 1408 and antenna 1410 of the communications device 1400 in FIG. 14. Means for receiving or obtaining may include the transceiver(s) 232 and/or antenna(s) 234 of the BS 110 and/or transceiver 1408 and antenna 1410 of the communications device 1400 in FIG. 14.

In certain aspects, the computer-readable medium/memory 1430 is configured to store instructions (e.g., computer-executable code, processor-executable code) that when executed by the one or more processors 1420, cause the one or more processors 1420 to perform the method 1200 described with respect to FIG. 12, or any aspect related to it. Note that reference to a processor performing a function of communications device 1400 may include one or more processors performing that function of communications device 1400.

As shown in FIG. 14, the communications device 1400 may include circuitry for transmitting, to an Rx node, an indication of a reference Tx signal quality metric value for a reference signal associated with a reference Tx configuration parameter value and respective Tx signal quality metric values for a plurality of Tx configuration parameter values (circuitry 1465).

As shown in FIG. 14, the communications device 1400 may include, stored in computer-readable medium/memory 1430, code for transmitting, to an Rx node, an indication of a reference Tx signal quality metric value for a reference signal associated with a reference Tx configuration parameter value and respective Tx signal quality metric values for a plurality of Tx configuration parameter values (code 1470).

As shown in FIG. 14, the communications device 1400 may include circuitry for transmitting, to the Rx node, the reference signal using the reference Tx configuration parameter value (circuitry 1475).

As shown in FIG. 14, the communications device 1400 may include, stored in computer-readable medium/memory 1430, code for transmitting, to the Rx node, the reference signal using the reference Tx configuration parameter value (code 1480).

As shown in FIG. 14, the communications device 1400 may include circuitry for transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values (circuitry 1485).

As shown in FIG. 14, the communications device 1400 may include, stored in computer-readable medium/memory 1430, code for transmitting, to the Rx node, a transmission using a Tx configuration parameter value, of the plurality of Tx configuration parameter values, that is based at least in part on CSI values, for the plurality of Tx configuration parameter values, that are based at least in part on the reference signal, the reference Tx signal quality metric value, and the respective Tx signal quality metric values for the plurality of Tx configuration parameter values (code 1490).

Various components of the communications device 1400 may provide means for performing the method 1200 described with respect to FIG. 12, or any aspect related to it. For example, means for transmitting, sending, or outputting for transmission may include the transceiver(s) 232 and/or antenna(s) 234 of the BS 110 and/or transceiver 1408 and antenna 1410 of the communications device 1400 in FIG. 14. Means for receiving or obtaining may include the transceiver(s) 232 and/or antenna(s) 234 of the BS 110 and/or transceiver 1408 and antenna 1410 of the communications device 1400 in FIG. 14.

FIG. 14 is provided as an example. Other examples may differ from what is described in connection with FIG. 14.

The following provides an overview of some Aspects of the present disclosure:
Aspect 1: A method of wireless communication performed by a receive (Rx) node, comprising: receiving, from a transmit (Tx) node, a reference signal associated with a reference Tx configuration parameter value; obtaining a set of channel state information (CSI) values, including respective CSI values for a plurality of Tx configuration parameter values, that are based at least in part on the reference signal associated with the reference Tx configuration parameter value; and receiving, from the Tx node, a transmission that is associated with a Tx configuration parameter value, of the plurality of Tx configuration parameter values, that is based at least in part on the respective CSI values for the plurality of Tx configuration parameter values.
Aspect 2: The method of Aspect 1, further comprising: receiving, from the Tx node, an indication of the reference Tx configuration parameter value and the plurality of Tx configuration parameter values.
Aspect 3: The method of any of Aspects 1-2, wherein: the plurality of Tx configuration parameter values include a plurality of values for a first Tx configuration parameter; the reference Tx configuration parameter value is a reference value for the first Tx configuration parameter; and the first Tx configuration parameter is a power amplifier backoff value, a Tx power offset, a digital-to-analog converter resolution, or a crest factor reduction parameter.
Aspect 4: The method of any of Aspects 1-3, further comprising: receiving, from the Tx node, an indication of a reference Tx signal quality metric value for the reference signal and respective Tx signal quality metric values for the plurality of Tx configuration parameter values.
Aspect 5: The method of Aspect 4, wherein: the respective Tx signal quality metric values for the plurality of Tx configuration parameter values include respective values for a first Tx signal quality metric; the reference Tx signal quality metric value is a value for the first Tx signal quality metric for the reference signal; and the first Tx signal quality metric is an error vector magnitude (EVM), a Tx signal-to-noise ratio (SNR), or a maximum achievable rate limit.
Aspect 6: The method of Aspect 4, wherein obtaining the set of CSI values comprises: deriving the respective CSI values for the plurality of Tx configuration parameter values based at least in part on the respective Tx signal quality metric values for the plurality of Tx configuration parameter values, the reference Tx signal quality metric value, and a measurement of the reference signal.
Aspect 7: The method of Aspect 6, wherein the reference Tx signal quality metric value is a reference error vector magnitude (EVM) value and the respective Tx signal quality metric values include respective EVM values for the plurality of Tx configuration parameter values, and wherein deriving the respective CSI values further comprises: deriving respective signal-to-noise ratio (SNR) values for the plurality of Tx configuration parameter values based at least in part on the respective EVM values for the plurality of Tx configuration parameter values, the reference EVM value, and a measured SNR value for the reference signal.
Aspect 8: The method of any of Aspects 1-7, further comprising: transmitting, to the Tx node, a report including one or more of the respective CSI values for the plurality of Tx configuration parameter values.
Aspect 9: The method of Aspect 8, further comprising: transmitting, to the Tx node, an indication of a UE capability for deriving the set of CSI values.
Aspect 10: The method of Aspect 9, wherein the indication of the UE capability for deriving the set of CSI values includes an indication of a preferred reference Tx signal quality metric value for the reference signal.
Aspect 11: The method of any of Aspects 8-10, further comprising: receiving a reporting configuration for reporting the one or more of the respective CSI values for the plurality of Tx configuration parameter values, wherein transmitting the report comprises transmitting the report in accordance with the reporting configuration.
Aspect 12: The method of Aspect 11, wherein the reporting configuration indicates one or more triggering conditions for reporting the one or more of the respective CSI values for the plurality of Tx configuration parameter values, and wherein transmitting the report in accordance with the reporting configuration comprises: transmitting the report in connection with a triggering condition, of the one or more triggering conditions, being satisfied.
Aspect 13: The method of Aspect 12, wherein the one or more triggering conditions include a triggering condition that is satisfied in connection with a difference between a respective CSI value for at least one Tx configuration parameter value of the plurality of Tx configuration parameter values and a baseline CSI value for the reference signal satisfying a threshold.
Aspect 14: The method of any of Aspects 11-13, wherein the reporting configuration indicates a selection criterion for selecting the one or more of the respective CSI values for the plurality of Tx configuration parameter values to be included in the report.
Aspect 15: The method of Aspect 14, wherein the selection criterion indicates one or more selected Tx configuration parameter values of the plurality of Tx configuration parameter values, and wherein the one or more of the respective CSI values included in the report include the respective CSI values for the one or more selected Tx configuration parameter values.
Aspect 16: The method of Aspect 14, wherein the selection criterion indicates that CSI values, of the respective CSI values for the plurality of Tx configuration parameter values, that are within a range of a baseline CSI value for the reference signal are to be included in the report.
Aspect 17: The method of Aspect 14, wherein the selection criterion indicates that CSI values, of the respective CSI values for the plurality of Tx configuration parameter values, that are outside of a range of a baseline CSI value for the reference signal are to be included in the report.
Aspect 18: The method of Aspect 14, wherein the selection criterion indicates a quantity of CSI values to be included in the report.
Aspect 19: The method of Aspect 18, further comprising: receiving an indication of respective cost metric values for the plurality of Tx configuration parameter values, wherein the one or more of the respective CSI values included in the report include the quantity of CSI values selected from the respective CSI values for the plurality of Tx configuration parameter values based at least in part on the respective cost metric values for the plurality of Tx configuration parameter values.
Aspect 20: The method of any of Aspects 8-19, wherein the report indicates, for each CSI value of the one or more of the respective CSI values included in the report, a relative value for the CSI value with respect to a baseline CSI value for the reference signal.
Aspect 21: The method of Aspect 20, wherein the relative value, for each CSI value of the one or more of the respective CSI values included in the report, is an offset between the CSI value and the baseline CSI value.
Aspect 22: The method of any of Aspects 8-21, wherein the respective CSI values for the plurality of Tx configuration parameter values may include respective channel quality index (CQI) values for the plurality of Tx configuration parameter values, respective modulation and coding scheme (MCS) values for the plurality of Tx configuration parameter values, or respective signal-to-interference-plus-noise ratio (SINR) values for the plurality of Tx configuration parameter values.
Aspect 23: The method of any of Aspects 8-22, wherein the report includes the one or more of the respective CSI values for the plurality of Tx configuration parameter values and a baseline CSI value for the reference signal.
Aspect 24: The method of any of Aspects 8-22, wherein transmitting the report comprises: transmitting a first report including a baseline CSI value for the reference signal; and transmitting a second report including respective relative CSI values, with respect to the baseline CSI value, for one or more of the plurality of Tx configuration parameter values that are different from the reference Tx configuration parameter value.
Aspect 25: The method of any of Aspects 8-24, wherein the report includes an indication of a mapping between different Tx configuration parameter values, of the plurality of Tx configuration parameter values, and the respective CSI values for the different Tx configuration parameter values.
Aspect 26: The method of Aspect 25, wherein the indication of the mapping includes an indication of a linear function with a slope and an offset that characterize the mapping.
Aspect 27: The method of any of Aspects 1-7, further comprising: selecting the Tx configuration parameter value of the plurality of Tx configuration parameter values based at least in part on the respective CSI values for the plurality of Tx configuration parameter values.
Aspect 28: The method of Aspect 27, further comprising receiving, from the Tx node, an indication of respective cost metric values for the plurality of Tx configuration parameter values, wherein selecting the Tx configuration parameter value of the plurality of Tx configuration parameter values comprises: selecting the Tx configuration parameter value of the plurality of Tx configuration parameter values based at least in part on the respective CSI values for the plurality of Tx configuration parameter values, the respective cost metric values for the plurality of Tx configuration parameter values, and a performance metric.
Aspect 29: The method of any of Aspects 27-28, further comprising: transmitting, to the Tx node, scheduling information scheduling the transmission from the Tx node and indicating that the Tx configuration parameter value of the plurality of Tx configuration parameter values is to be used for the transmission.
Aspect 30: A method of wireless communication performed by a transmit (Tx) node, comprising: transmitting, to a receive (Rx) node, an indication of a reference Tx signal quality metric value for a reference signal associated with a reference Tx configuration parameter value and respective Tx signal quality metric values for a plurality of Tx configuration parameter values; transmitting, to the Rx node, the reference signal using the reference Tx configuration parameter value; and transmitting, to the Rx node, a transmission using a Tx configuration parameter value, of the plurality of Tx configuration parameter values, that is based at least in part on channel state information (CSI) values, for the plurality of Tx configuration parameter values, that are based at least in part on the reference signal, the reference Tx signal quality metric value, and the respective Tx signal quality metric values for the plurality of Tx configuration parameter values.
Aspect 31: The method of Aspect 30, further comprising: transmitting an indication of the reference Tx configuration parameter value and the plurality of Tx configuration parameter values.
Aspect 32: The method of any of Aspects 30-31, wherein: the plurality of Tx configuration parameter values include a plurality of values for a first Tx configuration parameter; the reference Tx configuration parameter value is a reference value for the first Tx configuration parameter; and the first Tx configuration parameter is a power amplifier backoff value, a Tx power offset, a digital-to-analog converter resolution, or a crest factor reduction parameter.
Aspect 33: The method of any of Aspects 30-32, wherein: the respective Tx signal quality metric values for the plurality of Tx configuration parameter values include respective values for a first Tx signal quality metric; the reference Tx signal quality metric value is a value for the first Tx signal quality metric for the reference signal; and the first Tx signal quality metric is an error vector magnitude (EVM), a Tx signal-to-noise ratio (SNR), or a maximum achievable rate limit.
Aspect 34: The method of any of Aspects 30-33, further comprising: receiving, from the Rx node, a report including respective CSI values for one or more of the plurality of Tx configuration parameter values.
Aspect 35: The method of Aspect 34, further comprising: receiving, from the Tx node, an indication of a UE capability for deriving the CSI values.
Aspect 36: The method of Aspect 35, wherein the indication of the UE capability for deriving the CSI values includes an indication of a preferred reference Tx signal quality metric value for the reference signal.
Aspect 37: The method of any of Aspects 34-35, further comprising: transmitting a reporting configuration for reporting the respective CSI values for the one or more of the plurality of Tx configuration parameter values.
Aspect 38: The method of Aspect 37, wherein the reporting configuration indicates one or more triggering conditions for reporting the one or more of the respective CSI values for the plurality of Tx configuration parameter values, and wherein receiving the report comprises: receiving the report in connection with a triggering condition, of the one or more triggering conditions, being satisfied.
Aspect 39: The method of Aspect 38, wherein the one or more triggering conditions include a triggering condition that is satisfied in connection with a difference between a respective CSI value for at least one Tx configuration parameter value of the plurality of Tx configuration parameter values and a baseline CSI value for the reference signal satisfying a threshold.
Aspect 40: The method of any of Aspects 37-39, wherein the reporting configuration indicates a selection criterion for selecting the respective CSI values for the one or more of the plurality of Tx configuration parameter values to be included in the report.
Aspect 41: The method of Aspect 40, wherein the selection criterion indicates one or more selected Tx configuration parameter values of the plurality of Tx configuration parameter values, and wherein the respective CSI values included in the report include respective CSI values for the one or more selected Tx configuration parameter values.
Aspect 42: The method of Aspect 40, wherein the selection criterion indicates that CSI values, of the CSI values for the plurality of Tx configuration parameter values, that are within a range of a baseline CSI value for the reference signal are to be included in the report.
Aspect 43: The method of Aspect 40, wherein the selection criterion indicates that CSI values, of the CSI values for the plurality of Tx configuration parameter values, that are outside of a range of a baseline CSI value for the reference signal are to be included in the report.
Aspect 44: The method of Aspect 40, wherein the selection criterion indicates a quantity of CSI values to be included in the report.
Aspect 45: The method of Aspect 44, further comprising: transmitting an indication of respective cost metric values for the plurality of Tx configuration parameter values, wherein the respective CSI values included in the report include respective CSI values for the quantity of Tx configuration parameter values selected based at least in part on the respective cost metric values for the plurality of Tx configuration parameter values.
Aspect 46: The method of any of Aspects 34-45, wherein the report indicates, for each CSI value of the respective CSI values included in the report, a relative value for the CSI value with respect to a baseline CSI value for the reference signal.
Aspect 47: The method of Aspect 46, wherein the relative value, for each CSI value of the respective CSI values included in the report, is an offset between the CSI value and the baseline CSI value.
Aspect 48: The method of any of Aspects 34-47, wherein the respective CSI values for the plurality of Tx configuration parameter values may include respective channel quality index (CQI) values for the plurality of Tx configuration parameter values, respective modulation and coding scheme (MCS) values for the plurality of Tx configuration parameter values, or respective signal-to-interference-plus-noise ratio (SINR) values for the plurality of Tx configuration parameter values.
Aspect 49: The method of any of Aspects 34-48, wherein the report includes the respective CSI values for the one or more of the plurality of Tx configuration parameter values and a baseline CSI value for the reference signal.
Aspect 50: The method of any of Aspects 34-48, wherein receiving the report comprises: receiving a first report including a baseline CSI value for the reference signal; and transmitting a second report including respective relative CSI values, with respect to the baseline CSI value, for one or more of the plurality of Tx configuration parameter values that are different from the reference Tx configuration parameter value.
Aspect 51: The method of any of Aspects 34-50, wherein the report includes an indication of a mapping between different Tx configuration parameter values, of the plurality of Tx configuration parameter values, and respective CSI values for the different Tx configuration parameter values.
Aspect 52: The method of Aspect 51, wherein the indication of the mapping includes an indication of a linear function with a slope and an offset that characterize the mapping.
Aspect 53: The method of any of Aspects 34-52, further comprising: selecting the Tx configuration parameter value, of the plurality of Tx configuration parameter values, based at least in part on the respective CSI values, for the one or more of the plurality of Tx configuration parameter values, included in the report.
Aspect 54: The method of any of Aspects 30-33, further comprising: transmitting an indication of respective cost metric values for the plurality of Tx configuration parameter values.
Aspect 55: The method of any of Aspects 30-33 and 54, further comprising: receiving, from the Rx node, scheduling information scheduling the transmission to the Tx node and indicating that the Tx configuration parameter value, of the plurality of Tx configuration parameter values, is to be used for the transmission.
Aspect 56: An apparatus for wireless communication at a device, comprising a processor; memory coupled with the processor; and instructions stored in the memory and executable by the processor to cause the apparatus to perform the method of one or more of Aspects 1-55.
Aspect 57: A device for wireless communication, comprising a memory and one or more processors coupled to the memory, the one or more processors configured to perform the method of one or more of Aspects 1-55.
Aspect 58: An apparatus for wireless communication, comprising at least one means for performing the method of one or more of Aspects 1-55.
Aspect 59: A non-transitory computer-readable medium storing code for wireless communication, the code comprising instructions executable by a processor to perform the method of one or more of Aspects 1-55.
Aspect 60: A non-transitory computer-readable medium storing a set of instructions for wireless communication, the set of instructions comprising one or more instructions that, when executed by one or more processors of a device, cause the device to perform the method of one or more of Aspects 1-55.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A receive (Rx) node for wireless communication, comprising:
a memory; and
one or more processors, coupled to the memory, configured to:
receive, from a transmit (Tx) node, a reference signal associated with a reference Tx configuration parameter value;
obtain a set of channel state information (CSI) values, including respective CSI values for a plurality of Tx configuration parameter values, that are based at least in part on the reference signal associated with the reference Tx configuration parameter value; and
receive, from the Tx node, a transmission that is associated with a Tx configuration parameter value, of the plurality of Tx configuration parameter values, that is based at least in part on the respective CSI values for the plurality of Tx configuration parameter values.

2. The Rx node of claim 1, wherein the one or more processors are further configured to:
receive, from the Tx node, an indication of the reference Tx configuration parameter value and the plurality of Tx configuration parameter values.

3. The Rx node of claim 1, wherein:
the plurality of Tx configuration parameter values include a plurality of values for a first Tx configuration parameter;
the reference Tx configuration parameter value is a reference value for the first Tx configuration parameter; and
the first Tx configuration parameter is a power amplifier backoff value, a Tx power offset, a digital-to-analog converter resolution, or a crest factor reduction parameter.

4. The Rx node of claim 1, wherein the one or more processors are further configured to:
receive, from the Tx node, an indication of a reference Tx signal quality metric value for the reference signal and respective Tx signal quality metric values for the plurality of Tx configuration parameter values.

5. The Rx node of claim 4, wherein:
the respective Tx signal quality metric values for the plurality of Tx configuration parameter values include respective values for a first Tx signal quality metric;
the reference Tx signal quality metric value is a value for the first Tx signal quality metric for the reference signal; and
the first Tx signal quality metric is an error vector magnitude (EVM), a Tx signal-to-noise ratio (SNR), or a maximum achievable rate limit.

6. The Rx node of claim 4, wherein the one or more processors, to obtain the set of CSI values, are configured to:
derive the respective CSI values for the plurality of Tx configuration parameter values based at least in part on the respective Tx signal quality metric values for the plurality of Tx configuration parameter values, the reference Tx signal quality metric value, and a measurement of the reference signal.

7. The Rx node of claim 6, wherein the reference Tx signal quality metric value is a reference error vector magnitude (EVM) value and the respective Tx signal quality metric values include respective EVM values for the plurality of Tx configuration parameter values, and wherein deriving the respective CSI values further comprises:
derive respective signal-to-noise ratio (SNR) values for the plurality of Tx configuration parameter values based at least in part on the respective EVM values for the plurality of Tx configuration parameter values, the reference EVM value, and a measured SNR value for the reference signal.

8. The Rx node of claim 1, wherein the one or more processors are further configured to:
transmit, to the Tx node, a report including one or more of the respective CSI values for the plurality of Tx configuration parameter values.

9. The Rx node of claim 8, wherein the one or more processors are further configured to:
receive a reporting configuration for reporting the one or more of the respective CSI values for the plurality of Tx configuration parameter values, wherein transmitting the report comprises transmitting the report in accordance with the reporting configuration.

10. The Rx node of claim 9, wherein the reporting configuration indicates one or more triggering conditions for reporting the one or more of the respective CSI values for the plurality of Tx configuration parameter values, and wherein transmitting the report in accordance with the reporting configuration comprises:
transmit the report in connection with a triggering condition, of the one or more triggering conditions, being satisfied.

11. The Rx node of claim 10, wherein the one or more triggering conditions include a triggering condition that is satisfied in connection with a difference between a respective CSI value for at least one Tx configuration parameter value of the plurality of Tx configuration parameter values and a baseline CSI value for the reference signal satisfying a threshold.

12. The Rx node of claim 9, wherein the reporting configuration indicates a selection criterion for selecting the one or more of the respective CSI values for the plurality of Tx configuration parameter values to be included in the report.

13. The Rx node of claim 12, wherein the selection criterion indicates a quantity of CSI values to be included in the report.

14. The Rx node of claim 13, wherein the one or more processors are further configured to:
receive an indication of respective cost metric values for the plurality of Tx configuration parameter values, wherein the one or more of the respective CSI values included in the report include the quantity of CSI values selected from the respective CSI values for the plurality of Tx configuration parameter values based at least in part on the respective cost metric values for the plurality of Tx configuration parameter values.

15. The Rx node of claim 8, wherein the report indicates, for each CSI value of the one or more of the respective CSI values included in the report, a relative value for the CSI value with respect to a baseline CSI value for the reference signal.

16. The Rx node of claim 8, wherein the respective CSI values for the plurality of Tx configuration parameter values may include respective channel quality index (CQI) values for the plurality of Tx configuration parameter values, respective modulation and coding scheme (MCS) values for the plurality of Tx configuration parameter values, or respective signal-to-interference-plus-noise ratio (SINR) values for the plurality of Tx configuration parameter values.

17. The Rx node of claim 8, wherein the report includes the one or more of the respective CSI values for the plurality of Tx configuration parameter values and a baseline CSI value for the reference signal.

18. The Rx node of claim 8, wherein the one or more processors, to transmit the report, are configured to:
transmit a first report including a baseline CSI value for the reference signal; and
transmit a second report including respective relative CSI values, with respect to the baseline CSI value, for one or more of the plurality of Tx configuration parameter values that are different from the reference Tx configuration parameter value.

19. The Rx node of claim 8, wherein the report includes an indication of a mapping between different Tx configuration parameter values, of the plurality of Tx configuration parameter values, and the respective CSI values for the different Tx configuration parameter values, and wherein the indication of the mapping includes an indication of a linear function with a slope and an offset that characterize the mapping.

20. The Rx node of claim 1, wherein the one or more processors are further configured to:
select the Tx configuration parameter value of the plurality of Tx configuration parameter values based at least in part on the respective CSI values for the plurality of Tx configuration parameter values.

21. The Rx node of claim 20, wherein the one or more processors are further configured to receive, from the Tx node, an indication of respective cost metric values for the plurality of Tx configuration parameter values, wherein selecting the Tx configuration parameter value of the plurality of Tx configuration parameter values comprises:
select the Tx configuration parameter value of the plurality of Tx configuration parameter values based at least in part on the respective CSI values for the plurality of Tx configuration parameter values, the respective cost metric values for the plurality of Tx configuration parameter values, and a performance metric.

22. The Rx node of claim 20, wherein the one or more processors are further configured to:
transmit, to the Tx node, scheduling information scheduling the transmission from the Tx node and indicating that the Tx configuration parameter value of the plurality of Tx configuration parameter values is to be used for the transmission.

23. A transmit (Tx) node for wireless communication, comprising:
a memory; and
one or more processors, coupled to the memory, configured to:
transmit, to a receive (Rx) node, an indication of a reference Tx signal quality metric value for a reference signal associated with a reference Tx configuration parameter value and respective Tx signal quality metric values for a plurality of Tx configuration parameter values;
transmit, to the Rx node, the reference signal using the reference Tx configuration parameter value; and
transmit, to the Rx node, a transmission using a Tx configuration parameter value, of the plurality of Tx configuration parameter values, that is based at least in part on channel state information (CSI) values, for the plurality of Tx configuration parameter values, that are based at least in part on the reference signal, the reference Tx signal quality metric value, and the respective Tx signal quality metric values for the plurality of Tx configuration parameter values.

24. The Tx node of claim 23, wherein:
the plurality of Tx configuration parameter values include a plurality of values for a first Tx configuration parameter;
the reference Tx configuration parameter value is a reference value for the first Tx configuration parameter; and
the first Tx configuration parameter is a power amplifier backoff value, a Tx power offset, a digital-to-analog converter resolution, or a crest factor reduction parameter.

25. The Tx node of claim 23, wherein:
the respective Tx signal quality metric values for the plurality of Tx configuration parameter values include respective values for a first Tx signal quality metric;
the reference Tx signal quality metric value is a value for the first Tx signal quality metric for the reference signal; and
the first Tx signal quality metric is an error vector magnitude (EVM), a Tx signal-to-noise ratio (SNR), or a maximum achievable rate limit.

26. The Tx node of claim 23, wherein the one or more processors are further configured to:
receive, from the Rx node, a report including respective CSI values for one or more of the plurality of Tx configuration parameter values.

27. The Tx node of claim 26, wherein the one or more processors are further configured to:
select the Tx configuration parameter value, of the plurality of Tx configuration parameter values, based at least in part on the respective CSI values, for the one or more of the plurality of Tx configuration parameter values, included in the report.

28. The Tx node of claim 23, wherein the one or more processors are further configured to:
receive, from the Rx node, scheduling information scheduling the transmission to the Tx node and indicating that the Tx configuration parameter value, of the plurality of Tx configuration parameter values, is to be used for the transmission.

29. A method of wireless communication performed by a receive (Rx) node, comprising:
receiving, from a transmit (Tx) node, a reference signal associated with a reference Tx configuration parameter value;
obtaining a set of channel state information (CSI) values, including respective CSI values for a plurality of Tx configuration parameter values, that are based at least in part on the reference signal associated with the reference Tx configuration parameter value; and
receiving, from the Tx node, a transmission that is associated with a Tx configuration parameter value, of the plurality of Tx configuration parameter values, that is based at least in part on the respective CSI values for the plurality of Tx configuration parameter values.

30. A method of wireless communication performed by a transmit (Tx) node, comprising:
transmitting, to a receive (Rx) node, an indication of a reference Tx signal quality metric value for a reference signal associated with a reference Tx configuration parameter value and respective Tx signal quality metric values for a plurality of Tx configuration parameter values;
transmitting, to the Rx node, the reference signal using the reference Tx configuration parameter value; and
transmitting, to the Rx node, a transmission using a Tx configuration parameter value, of the plurality of Tx configuration parameter values, that is based at least in part on channel state information (CSI) values, for the plurality of Tx configuration parameter values, that are based at least in part on the reference signal, the reference Tx signal quality metric value, and the respective Tx signal quality metric values for the plurality of Tx configuration parameter values.
